(19) United States
(12) Patent Application Publication
(10) Pub. No.: US 2025/0246934 A1
(43) Pub. Date: Jul. 31, 2025

(54) WIRELESS ENERGY AND INFORMATION TRANSMISSION

(71) Applicant: QUALCOMM Incorporated, San Diego, CA (US)

(72) Inventors: Xiaojie WANG, Hillsborough, NJ (US); Piyush GUPTA, Bridgewater, NJ (US); Junyi LI, Greentown, PA (US); Luanxia YANG, Beijing (CN)

(21) Appl. No.: 18/855,301

(22) PCT Filed: May 16, 2022
(86) PCT No.: PCT/CN2022/092929

§ 371 Date: Oct. 8, 2024

(51) Int. Cl. H02J 50/00; H04L 5/00

(52) U.S. Cl. CPC H02J 50/001; H04L 5/0094; H04L 5/0098

(57) ABSTRACT

A UE may be configured to receive a first energy signal in a first frequency band or CC dedicated for WET from one or more frequency bands or CCs associated with the WET, and harvest radio-frequency energy from the first energy signal using a power harvesting circuit. An energy transmitter may be configured to obtain an indication of the first frequency or CC dedicated for the WET and transmit the first energy signal in the first frequency band dedicated for the WET to the UE. A network entity may configure the first frequency band or CC dedicated for the WET, configure at least one WIT band including one or more of a DL WIT band carrying a DL channel, an UL WIT band carrying an UL channel, or a SL WIT band carrying a SL channel for the UE to communicate a data signal.

### TECHNICAL FIELD

The present disclosure relates generally to communication systems, and more particularly, to a method of wireless communication including a wireless energy transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment, an energy transmitter, and a network node. In one aspect, the UE may be configured to receive a first energy signal in a first frequency band or a first component carrier (CC) dedicated for wireless energy transmission (WET) from one or more frequency bands or one or more CCs associated with the WET, and harvest radio-frequency energy from the first energy signal using a power harvesting circuit based on receiving the first energy signal in the first frequency band dedicated for the WET. In another aspect, the energy transmitter may be configured to obtain an indication of a first frequency band or a first CC dedicated for WET from one or more frequency bands or one or more CCs associated with the WET, and transmit a first energy signal in the first frequency band dedicated for the WET to a UE. In another aspect, the network entity may be configured to configure a first frequency band or a first CC dedicated for WET from one or more frequency bands or one or more CCs associated with the WET for a network entity to transmit a first energy signal in the first frequency band dedicated for the WET to a UE, configure at least one WIT band including one or more of a downlink (DL) WIT band carrying a DL channel, an uplink (UL) WIT band carrying an UL channel, or a sidelink (SL) WIT band carrying a SL channel for the UE to communicate a data signal with the network node or another UE, and communicate the data signal with the UE in the at least one WIT band.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates a diagram of a radio frequency identification (RFID) tag that receives an energy transfer signal from an RFID reader, in accordance with various aspects of the present disclosure.

FIG. 5 is a diagram of a power harvesting circuit, in accordance with various aspects of the present disclosure.

FIG. 6 illustrates a set of wireless energy transmission (WET) bands.

FIG. 7A illustrates a bandwidth of a WET band.

FIG. 7B illustrates adjacent channel leakage-power ratio (ACLR) of a WET band.

FIG. 7C illustrates a WET band and a radio access technology (RAT) band.

FIGS. 8A, 8B, 8C, and 8D illustrate examples of the WET band/sub-channel and the wireless information transmission (WIT) band/sub-channel.

FIG. 9 is a call-flow diagram of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

Some passive devices may include a power harvesting circuit to harvest radio frequency (RF) energy from ambient radio signals. However, the ambient radio signals of the wireless communication may not be strong enough to support the energy harvesting passive device (or semi-passive device with an energy reservoir) within the wireless network. According to some aspects of the current disclosure, a dedicated wireless energy transmission band or sub-channel may be configured and an energy transmitter may be configured to transmit an energy signal to the passive device with the power harvesting circuit to turn on and communicate with the passive device. Aspects presented herein may help to provide a reliable energy source for such energy harvesting devices. A network entity may transmit energy signals and/or communication signals. Aspects presented herein enable cooperative energy transfer signaling between a network entity and a UE to provide more continuous energy transfer transmissions to one or more devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

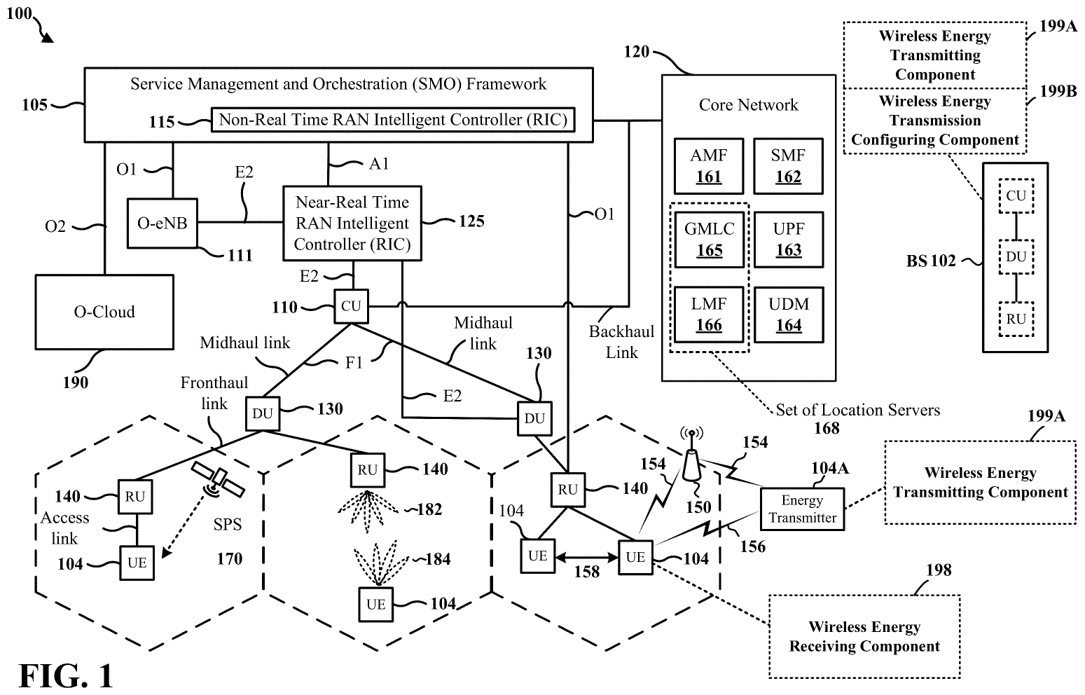

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

Certain UEs may be an energy transmitter 104A that may transmit energy signal 156 to the UE 104, and the UE 104 may be an energy receiver or a passive device with a power harvesting circuit that may harvest radio frequency (RF) energy from the energy signal 156 received from the energy transmitter 104A. At least one dedicated frequency band or sub-channel may be configured for the energy transmitter 104A to transmit the energy signal 156 and the UE 104 to receive the energy signal 156 and harvest the RF energy from the received energy signal 156.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a wireless energy receiving component 198 configured to receive a first energy signal in a first frequency band or a first CC dedicated for WET from one or more frequency bands or one or more CCs associated with the WET, and harvest radio-frequency energy from the first energy signal using a power harvesting circuit based on receiving the first energy signal in the first frequency band dedicated for the WET. In certain aspects, the energy transmitter 104A may include a wireless energy transmitting component 199A configured to obtain an indication of a first frequency band or a first CC dedicated for WET from one or more frequency bands or one or more CCs associated with the WET, and transmit a first energy signal in the first frequency band dedicated for the WET to a UE. In certain aspects, the base station 102 may include a wireless energy transmitting component 199A configured to obtain an indication of a first frequency band or a first CC dedicated for WET from one or more frequency bands or one or more CCs associated with the WET, and transmit a first energy signal in the first frequency band dedicated for the WET to a UE or a wireless energy transmission configuring component 199B configured to configure a first frequency band or a first CC dedicated for WET from one or more frequency bands or one or more CCs associated with the WET for a network entity to transmit a first energy signal in the first frequency band dedicated for the WET to a UE, configure at least one WIT band including one or more of a DL WIT band carrying a DL channel, an UL WIT band carrying an UL channel, or a SL WIT band carrying a SL channel for the UE to communicate a data signal with the network node or another UE, and communicate the data signal with the UE in the at least one WIT band. Although the following description may be focused on 5G NR, the concepts described herein may be applicable to other similar areas, such as LTE, LTE-A, CDMA, GSM, and other wireless technologies.

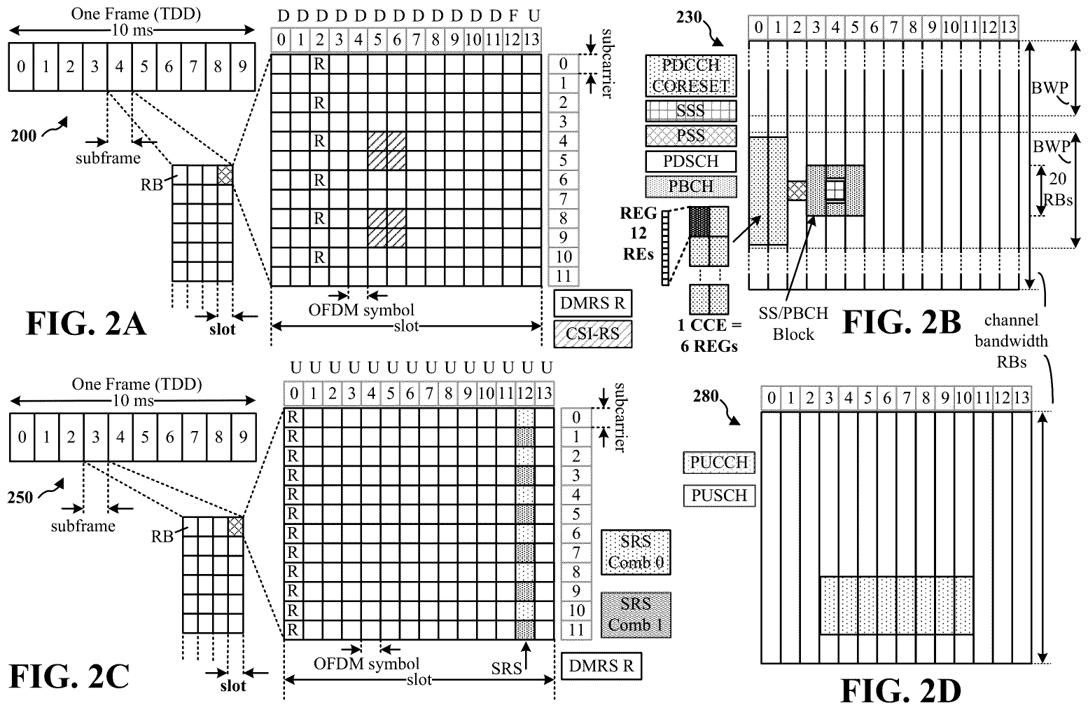

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

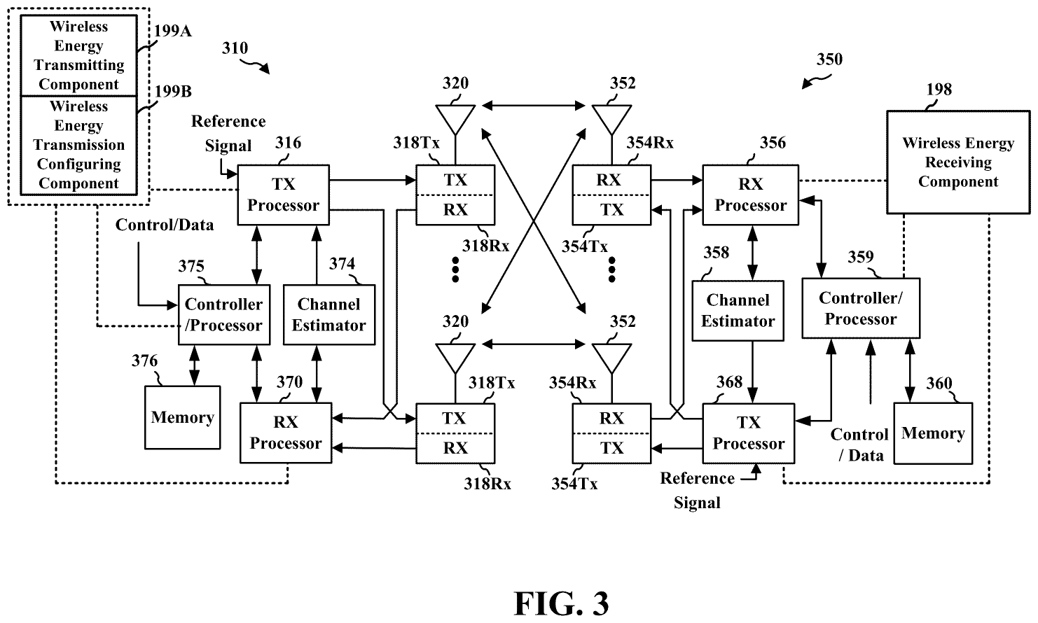

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the a wireless energy receiving component 198 of FIG. 1. At least one of the TX processor 316, the RX processor 370, and the controller/processor 375 may be configured to perform aspects in connection with the wireless energy transmitting component 199A of FIG. 1.

At least one of the TX processor 316, the RX processor 370, and the controller/processor 375 may be configured to perform aspects in connection with the wireless energy transmission configuring component 199B of FIG. 1.

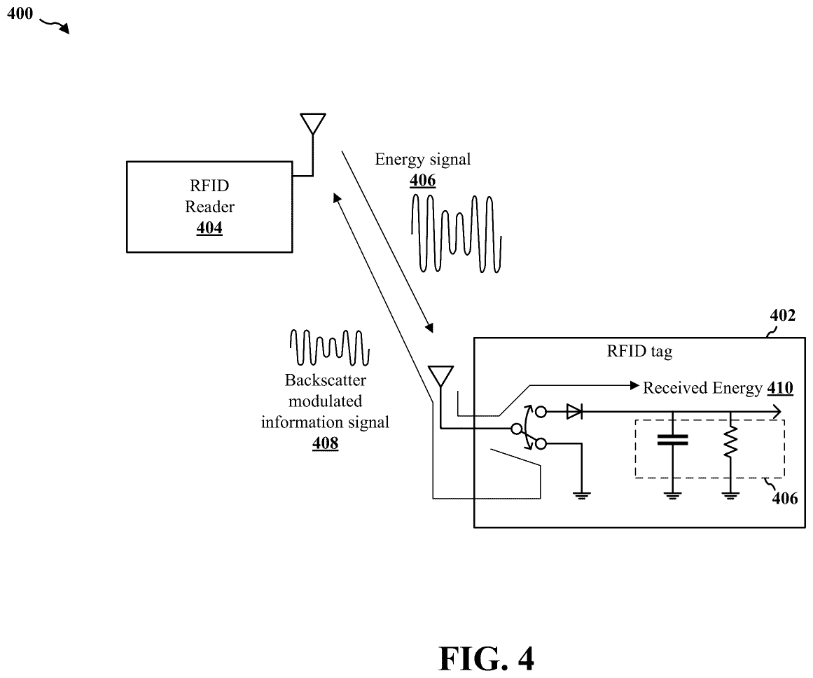

FIG. 4 illustrates a diagram 400 of an RFID tag 402 that receives an energy transfer signal 406 from an RFID reader 404. Such an RFID tag 402 is one example of an energy receiver that may obtain energy from an energy transfer signal (or an energy signal) from an energy transmitter (e.g., the RFID reader 404). An energy transfer signal 406 may be used for various industrial IoT (IIoT) applications. For example, RFID technology may be used for inventory/asset management both inside and outside of warehouses, network sensors in factories, logistics devices, manufacturing settings, agricultural applications, smart homes, etc. RFID technology may also be deployed in association with cellular infrastructure for wireless applications. RFID devices may include a transponder (e.g., the RFID tag 402) that emits an information-bearing signal, such as a backscattered modulated information signal 408, upon receiving a signal from the RFID reader 404. That is, the RFID reader 404 may transmit the energy transfer signal 406 as well as an information signal to a passive RFID microchip (e.g., RFID tag 402) that operates without a battery source.

The RFID tag 402 may be configured to operate without the battery source at a low operational expenditure (OPEX), low maintenance cost, and/or increased lifecycle. Other types of RFID tags may include battery sources. For example, semi-passive RFID devices and active RFID devices may have a battery source, but may also be associated with a higher cost. If the RFID reader 404 is able to provide enough received energy 410 to the RFID tag 402, the RFID tag 402 may harvest the received energy 410 to perform an operation during communication occasions or may harvest the received energy 410 to charge an associated battery. Passive RFID tags may harvest the received energy 410 over-the-air in order to power Tx/Rx circuitry at the RFID tag 402. The energy transfer signal 406 transmitted to the RFID tag 402 may trigger the backscattered modulated information signal 408 from the RFID tag 402. The RFID tag 402 may absorb or reflect signals from the RFID reader 404 based on the information to be communicated between the RFID tag 402 and the RFID reader 404. The RFID tag 402 may include a decreased number of active RF components (e.g., no active RF component) in some cases. By increasing a coverage area of the energy transfer signal 406, the RFID reader 404 and the RFID tag 402 may communicate at longer physical distances.

Wireless communication techniques associated with eMBB, URLLC, machine-type communication (MTC), etc., may be supported for passive IoT devices. Passive IoT devices are another example of an energy receiving device, such as 405 in FIG. 4. In examples, the RFID reader 404 may correspond to a base station or an entity at a base station, and the RFID tag 402 may correspond to a UE or be in communication with the UE. However, some wireless communication techniques may not support certain types of widespread RFID technology, such as passive IoT devices used for asset management, logistics, warehousing, and manufacturing, etc. Among other examples, passive IoT devices may include timing devices such as clocks, video devices, household tools, construction tools, lighting systems, etc.

In some aspects, the wireless communication techniques may support wireless energy transmission (WET) and/or wireless information transmission (WIT) to incorporate passive IoT devices into wireless networks. Using a cellular infrastructure, a base station/network entity may operate as the RFID reader 404 that transmits the energy transfer signal 406 to the RFID tag 402 for communicating with the passive IoT devices via RFID technology. The base station/network entity may provide energy to the passive IoT devices via the energy transfer signal 406 (e.g., which may correspond to 412a or 414) and may be configured to read/write information stored at the passive IoT devices. Information-bearing signals may be reflected from the passive IoT devices to the base station/network entity, which may read the reflected signal. For instance, the base station/network entity may decode information included in the information-bearing signals (e.g., backscattered modulated information signal 408) received from the passive IoT devices (e.g., RFID tag 402).

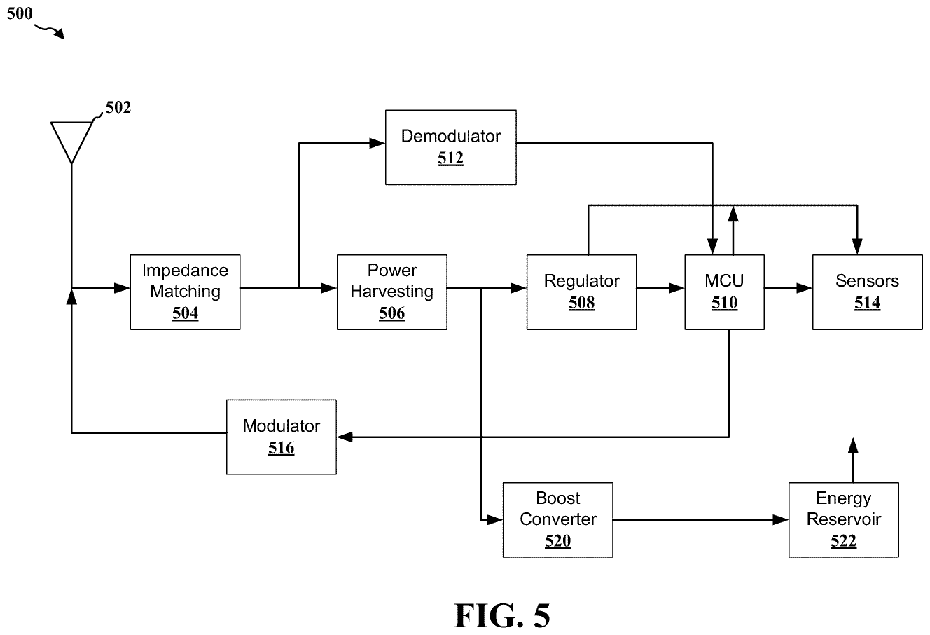

FIG. 5 is a diagram of a power harvesting circuit 500. In examples, the power harvesting circuit may be included at an RFID tag and may include few or no active components. The power harvesting circuit may be configured to operate at low power during an energy transfer procedure for RF power harvesting. The energy transfer signal may be received by an antenna 502 and communicated to an impedance matching component 504. The impedance matching component 504 may be tuned to an impedance of the antenna 502, so that an input to a power harvesting component 506 may be based on an increased power from the impedance matching component. An output of the impedance matching component 504 may also be demodulated by a demodulator 512 and provided to a microcontroller unit (MCU).

A non-linearity of the power harvesting component 506 may be generated at an output of the power harvesting component 506 based on characteristics of a diode associated with the power harvesting component 506. For instance, the power harvesting component 506 may include a diode that has to receive a minimum voltage/power from the antenna 502 and impedance matching component 504 in order to activate the diode. The minimum voltage/power that is input to the power harvesting component 506 to activate the diode may be larger than a power associated with an information signal. For example, the input power to the power harvesting component 506 may be larger than −20 dBm, although −10 dBM may be a minimum power to activate the diode/power harvesting component 506 in some cases. The power harvesting component 506 may be more efficient at lower frequencies at converting the energy transfer signal to power based on a capacitance and/or a resistance of the diode at the power harvesting component 506. In contrast to energy transfer signals, bits of an information signal may be decoded at power inputs as low as −100 dBm to −80 dBm.

A regulator 508 may receive an output of the power harvesting component 506. The regulator 508 may regulate the non-linearity of the power harvesting component 506 prior to providing the output of the power harvesting component 506 to the MCU 510. The MCU 510 may be configured to control sensors 514 in communication with the MCU 510 based on the harvested power and/or output a signal to a modulator 516 that modulates the output signal as feedback for antenna 502 and/or the impedance matching component 504.

The power harvesting circuit may include a boost converter 520 to receive the output of the power harvesting component 506. The boost converter may step up (or boost) the voltage of the output of the power harvesting component. The output of the boost converter 520 with the boosted voltage may be supplied to an energy reservoir 522. The energy reservoir 522 may receive the boosted voltage and store the energy harvested by the power harvesting component 506. The energy reservoir 522 may provide the stored power to other components that may need to turn on without the output of the power harvesting component 506. For example, the power harvesting circuit may determine that the energy transmitter that the energy signal received from the energy transmitter fails to meet a threshold value. If the energy density of the receive energy signal is lower than a turn-on voltage, the energy receiver may use the power stored in the energy reservoir to transmit an indication to the energy transmitter that the energy signal received from the energy transmitter failed to meet the threshold value.

In some aspects, the passive IoT devices may be incorporated into the wireless networks, and ambient RF signal may not provide sufficient power density to send the energy signal having the power density greater than or equal to a threshold value to activate (or turn on) the power harvesting circuit. In one example, the power density of the ambient RF signals (e.g., digital television signal (DTV), global system for mobile communication (GSM), 3G, or Wifi) may be lower than 10 nW/cm2. Here, the power level may vary over time and depends on the locations.

The wireless communication techniques may support wireless energy transmission (WET) and/or wireless information transmission (WIT) to incorporate passive IoT devices into wireless networks. That is, a dedicated frequency bands may be configured for wireless energy transmission to PIOT applications. The frequency band associated with the WET may be reserved for at least one of the WET, the WIT or the WET+WIT. The dedicated frequency band may provide the energy coverage for the pervasive, or perpetual wireless-powered IoT devices.

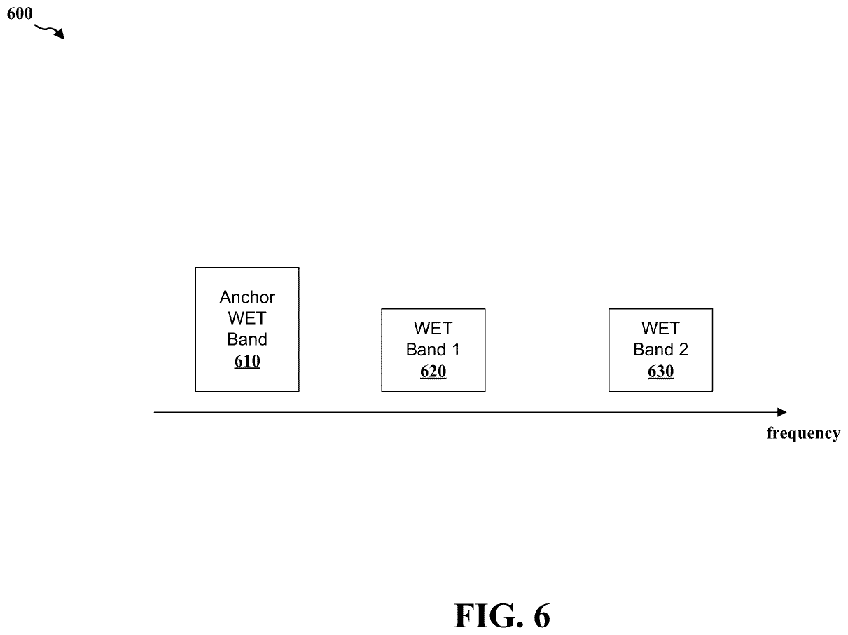

FIG. 6 illustrates a set of WET bands 600. Here, the set of the WET bands may refer to a set of bands or a set of CCs dedicated for transmitting and receiving energy signal for the WET operation. The set of WET bands 600 may include one or more WET bands or CCs. The network node may transmit energy signals in one or more of the CCs of the set of WET bands 600, and the UE may harvest energy from the energy signal received in the set of WET bands 600. In one aspect, each WET band of the set of WET bands may be configured to have a relatively narrower bandwidth. For example, each WET band of the set of WET bands may be configured with a single carrier or a bandwidth of a few kHz.

The set of WET bands 600 may include an anchor WET band 610. The anchor WET band 610 may be defined or configured for the UE to receive the energy signal to power up. The anchor WET band 610 may be configured as a common WET band for WET devices (e.g., the energy receiver) that may support the WET operation, e.g., in common across multiple cells. In one aspect, the anchor WET band 610 may be supported by all WET devices/cells (e.g., the IoT devices) configured with the WET while other WET bands (e.g., first WET band 620 and second WET band 630) may be defined or configured in a per cell manner. For example, a first cell may have WET band 1 620 configured to energy transfer in addition to the anchor WET band 610 but not WET band 2 630. A second cell may include WET band 2 630 configured for energy transfer and not WET band 1. The WET devices may initially harvest energy from the anchor WET band and then identify other WET bands based on signaling or measurements for a particular cell. That is, the WET devices may initially receive the energy signal on the anchor WET band to turn on the energy harvest circuit (e.g., the power harvesting circuit 500), and identify the other WET bands (e.g., the first WET band 620 or the second WET band 630). In one example, the anchor WET band 610 may include an indication of frequency bands associated with the first WET band 620 or the second WET band 630, and a WET device may identify the first WET band 620 and the second WET band 630 based on the indication included in the anchor WET band 610. In another aspect, a frequency offset relative to the anchor WET band 610 may be used to indicate the WET band 620 or the second WET band 630. A WET device may identify the first WET band 620 and the second WET band 630 based on the indication of the frequency offset relative to the anchor WET band 610. The WET device may select one of the first WET band 620 or the second WET band 630 that has a relatively higher energy, and match the impedance of the power harvesting circuit of the WET device based on the relatively higher energy. For example, the WET device may measure that energy signal received on the first WET band 620 has a relatively higher energy measurement than the second WET band 630, and the WET devices may tune the impedance circuit or select an impedance circuit matching the first WET band 620 to receive the energy signal in the first WET band 620 and harvest the radio-frequency (RF) energy.

The WET band or the WET CC may be associated with a WET frequency. Here, the WET frequency may be referred to a quantity of frequencies reserved or dedicated for transmitting and receiving energy signal for the WET operation. The WET frequency may be associated with the anchor WET band or anchor WET CC, and the WET frequency may be configured for the wireless powered devices such that it can optimize its power harvesting circuitry to the selected WET band (e.g., impedance matching network). The WET device (e.g., the energy receiver) may harvest the RF energy from one or more WET bands or CCs depending on a capability of the UE. In one aspect, the WET device may not expect to receive or decode information from the energy signals in the WET band.

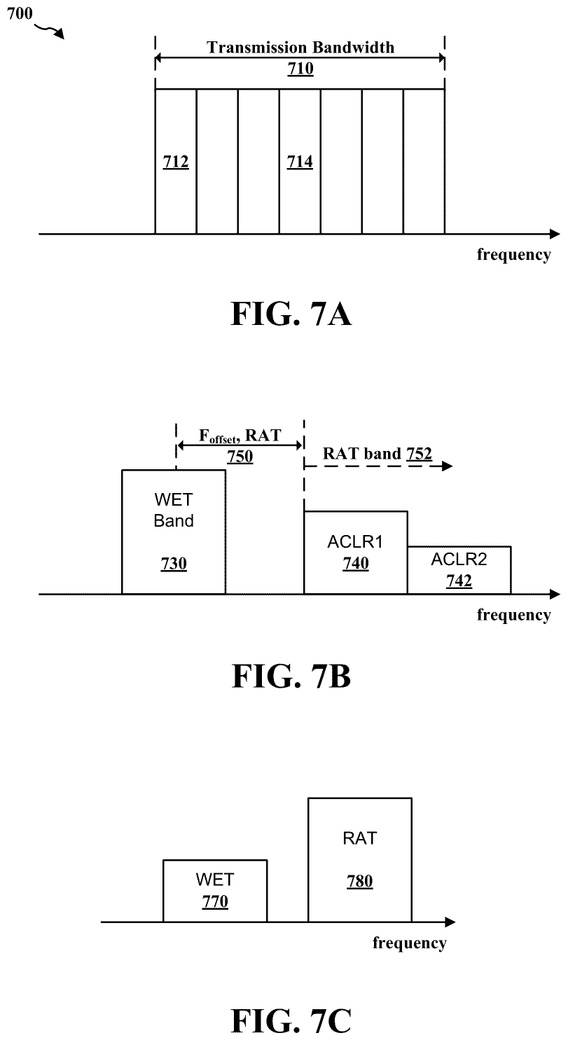

FIG. 7A illustrates a bandwidth 710 of the WET band 700. The WET band 700 dedicated for transmitting and receiving energy signal for the WET operation, and the WET frequency of the WET band 700, which may be a reserved quantity of frequencies for WET, may be associated with a transmission bandwidth 710. In some aspects, the transmission bandwidth 710 of the WET band 700 may include one or more WET sub-channels. A bandwidth of each WET subchannel of the one or more WET sub-channels or a number of the WET sub-channels may be configured based on the transmission bandwidth 710 of the WET band 700.

The energy transmitter may select one or more WET sub-channels to transmit the energy signal to the energy receiver. In one example, the energy transmitter may select the first WET sub-channel 712 to transmit the energy signal to the energy receiver. In another example, the first WET sub-channel 712 may be configured as a default WET sub-channel for the energy transmitter and the energy receiver to transmit and receive the energy signal.

In one aspect, a power spectral density (PSD) of the energy signal transmitted in one or more WET sub-channels of the WET band 700 may be greater than a PSD of the energy signal transmitted in the WET band 700. That is, the bandwidth of the first WET sub-channel 712 may be smaller than the transmission bandwidth 710 of the WET band 700, the PSD of the energy signal transmitted in the first WET sub-channel 712 of the WET band 700 may be greater than the PSD of the energy signal transmitted in the WET band 700.

In another aspect, the energy transmitter may be configured to hop or switch from one sub-channel to another sub-channel if some served energy receivers (ER) are in a bad position (e.g., due to multi-path reflection). That is, the energy transmitter may be configured to serve multiple energy receivers using the first WET sub-channel 712, and each of the multiple energy receivers may have different channel quality associated with the first WET sub-channel 712. If one or more energy receivers indicate that the energy signal received in the first WET sub-channel 712 is less than a threshold value, the energy transmitter may determine to hop or switch from the first WET sub-channel 712 to the second WET sub-channel 714. In one example, the energy transmitter may select the second WET sub-channel 714 based on receiving the indication from the one or more energy receivers that the energy signal received in the first WET sub-channel 712 is less than a threshold value and transmit an indication of the second WET sub-channel 714 to the one or more energy receivers. In another example, the energy transmitter may configure that the second WET sub-channel 714 may be used in case of frequency hopping or switching, and switch from the first WET sub-channel 712 to the second WET sub-channel 714.

The energy transmitter may regulate or define at least one transmission parameter of the energy signal transmitted in the WET band 700 per at least one regional specification or a base station class (e.g., a specification of the wireless communication operation, the energy transmitter, or the network node including the base station). In one example, the energy transmitter may define an effective isotropic radiated power (EIRP) and/or a PSD of the energy signal transmitted in the WET band 700 based on a specification of the wireless communication operation, the energy transmitter, or the network node including the base station.

FIG. 7B illustrates adjacent channel leakage-power ratio (ACLR) of the WET band 730. The WET band 730 may cause an out-of-band emission (e.g., spectrum emission masks, an operating band unwanted emissions (OBUE), etc.) and spurious emissions. That is, the transmission of the energy signal in the WET band 730 may lead to a leakage power into adjacent data channels for transmitting data signals, which may affect the data transmission in the adjacent channels. Here, the frequency band or CC associated with the data channel (e.g., at least one of a UL channel, a DL channel, or a sidelink (SL) channel) may be referred to as a radio access technology (RAT) band 752 or a RAT CC.

In one aspect, an at least one transmission parameter of the energy signal transmitted in the WET band 730 may be configured based on the ACLR specification of the WET band (e.g., the first ACLR 740 and the second ACLR 742). That is, the energy transmitter may be configured to determine the at least one transmission parameter of the energy signal transmitted in the WET band 730 based on the ACLR specification of the WET band 730 so that the power leaked into the RAT band 752 may not exceed a threshold value based on the first ACLR 740 and the second ACLR 742, and the parameters of the RAT band 752.

In one example, the ACLR specification of the WET band 730 may be based on an offset frequency 750 between at least one RAT band 752 and the WET band 730. That is, the ACLR specification associated with the energy signal of the WET band 730 (e.g., the first ACLR 740 and the second ACLR 742) may be defined or identified based on the offset frequency 750 between the WET band 730 and the RAT band 752.

In another example, the ACLR specification of the WET band 730 may be configured differently based on the RAT specification of the RAT band 752. That is, the ACLR specification of the WET band 730 may be defined depending on the RAT specification of the adjacent data channels (e.g., NR, LTE, etc.).

On the other hand, the WET band may have relaxed an out-of-band emission specification for the adjacent bands. That is, since the WET band 730 may be configured for transmitting the energy signal to transfer RF power and not for data transmission, the adjacent channels may be configured with a relaxed specification of the out-of-band emission with respect to the WET band. For example, the RAT band 752 may have no ACLR specification with respect to the WET band 730, and the network node transmitting the data signal in the RAT band 752 may disregard the effect of the data signal transmitted in the RAT band 752 with respect to the WET band 730.

FIG. 7C illustrates the WET band 770 and the RAT band 780. The WET band 770 may be associated with a WET frequency, which may refer to a reserved quantity of frequencies allocated for the WET band 770. The RAT band 780 may refer to a frequency band or CC for communicating the data channels between network entities (e.g., at least one of the UL channel, the DL channel, or the SL channel).

The transmission of the data signal or channel in the RAT band 780 may cause an out-of-band emission in the WET band 770. The RAT band 780 may have a reduced or less specification regarding the out-of-band emission in the WET band 770 caused by the data signal in the RAT band 780. That is, the energy signal transmitted in the WET band 770 does not carry a data signal, and therefore, the interference leakage caused by the RAT band 780 into the WET band 770 may not be significant for the WET operation. Accordingly, the RAT band 780 may be configured to consider less about the effect of the data signal transmitted in the RAT band 780 into the WET band 770. In some examples, the RAT band 780 may be configured with an ACLR specification, windowing and/or filtering specification, or inter-modulation suppression to reduce the power leakage into the adjacent bands, and the configured ACLR specification, windowing and/or filtering specification, or inter-modulation suppression may be relaxed or not applied with regard to adjacent WET band 770.

In one aspect, the RAT band 780 may have a relaxed specification of emission into the WET band 770 by the adjacent RAT band 780. For example, the RAT band 780 adjacent to the WET band 770 may be configured with relaxed or no ACLR specification for other channels' emission into the WET band 770. In another aspect, a shorter RF filter may be applied for the adjacent RAT band 780 or signals regarding the WET band 770. In another aspect, the RAT band 780 may be applied with a first windowing/filtering with higher emissions in the WET band 770 and a second windowing/filtering with smaller emissions in non-WET bands.

In another aspect, the RAT band 780 may be applied with a relaxed inter-modulation suppression due to non-linearity if inter-modulation products fall into WET band. The inter-modulation suppression may include controlling power amplification and filtering to reduce the inter-modulation product into the adjacent band. Accordingly, the adjacent RAT band 780 may be applied with a relaxed or no inter-modulation product into the adjacent WET band 770.

In another aspect, the RAT band 780 adjacent to the WET band 770 may perform multi-band transmissions for a better emission suppression. For example, the network node may transmit a data signal S₁(t) and a mitigating signal S₂(t) where the data signal S1(t) may be the data signal transmitted in the RAT band 780 and the mitigating signal s2(t) may be transmitted in the WET band S₂(t). Here, the mitigating signal S₂(t) may be designed or optimized to minimized the out-of-band emission into the frequencies between the RAT band 780 and the WET band 770, or to cancel/minimized the overall out-of-band emission of the data signal S₁(t) outside the band of RAT band 780.

In some aspects, one or more energy transmitters may access the WET band (e.g., the WET band 700, 730, or 770) and/or the WET sub-channels (e.g., the first WET sub-channel 712 or the second WET sub-channel 714) of the WET band. Various implementation may be configured for the one or more energy transmitters to select the WET band and/or the WET sub-channels of the WET band to transmit the energy signal to the associated WET devices (e.g., the energy receiver).

In one aspect, the access to the WET band/sub-channels may be restricted for the one or more energy transmitters and energy receivers. The network including the base station or the network node may reserve some WET band/sub-channels for dedicated energy signal transmissions (e.g., a set of energy signal with configured waveforms and/or power levels for one or more groups of energy receivers). The WET band/sub-channels reserved for the dedicated energy signal transmissions may be accessed by the configured energy transmitters (e.g., a network node, a base station, such as a gNB, certified ETs, or ET scheduled by the gNB). In one example, the ETs may receive a grant to transmit the energy signal on the WET band/sub-channels for a duration of time, and at a power level indicated in the grant received from the network node. In another example, the energy transmitters may transmit a message to the network node to reserve the WET band/sub-channel using a dedicated reservation signaling resources or using messages (e.g., NR, LTE, SL, etc.).

In another aspect, the one or more energy transmitters and energy receivers may have unlimited access to the WET band/sub-channels. That is, the one or more energy transmitters and energy receivers may access the WET channels anytime when they are necessary. In one example, the energy transmitter may be configured to receive a request from one or more energy receivers, and transmit the energy signal on the WET band/sub-channels based on receiving the request from the one or more energy receivers. In another example, the energy transmitter may also use the WET band/sub-channels for the out-of-band emission suppression. That is, the energy transmitter (or the network entity transmitting the data signal) may be configured to transmit a mitigating signal in the WET band/sub-channels to suppress the out-of-band emission caused by transmitting the data signals.

In another aspect, the access to the WET band/sub-channel may be based on a listen before transmission (LBT) procedure. That is, the energy transmitters may perform a LBT procedure on a WET band/sub-channel to detect an energy level of the WET band/sub-channel to determine whether the WET band/sub-channel is used by another energy transmitter to transmit the energy signal. If the detected energy level is smaller than a threshold, the energy transmitter may access and transmit the energy signal at a power level that may be determined by the energy detection. That is, based on determining that the WET band/sub-channel is not used by another energy transmitter based on the energy detection, the energy transmitter may access the WET band/sub-channel to transmit the energy signal. The power level of the energy signal may be determined based on the energy detection.

One example of the energy detection may be performed in the guard band of the WET band (i.e., measuring for the out-of-band emissions in the guard band caused by the energy signal in the WET band). Another example of the energy detection may be performed for the whole WET band. Another example of the energy detection may be performed for each of the WET sub-channel. In another example, the above examples of the energy detection may be be combined and the WET band/sub-channel access may be determined based on one or more energy detection results of the combined examples of the energy detections.

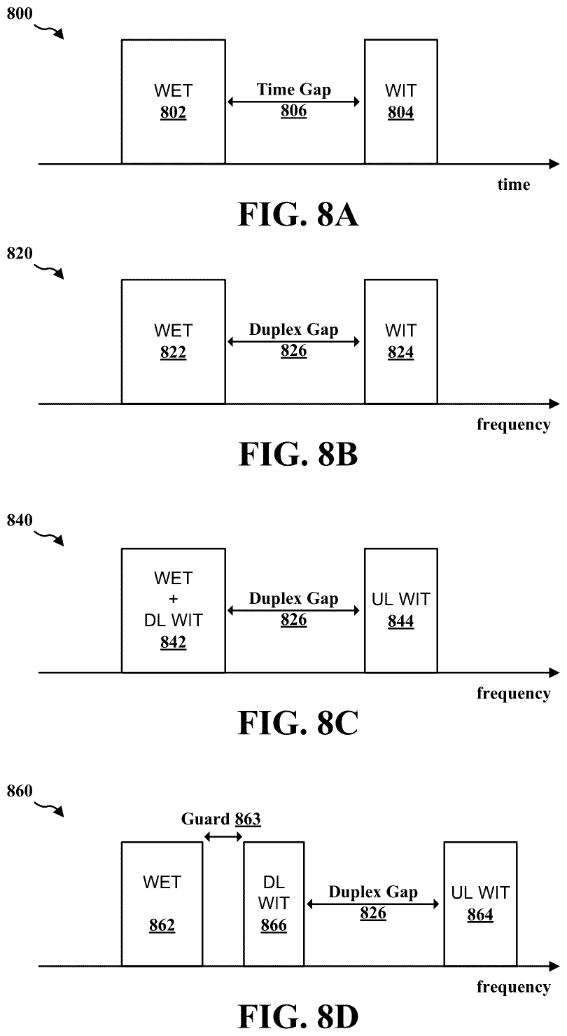

FIGS. 8A, 8B, 8C, and 8D illustrates examples 800, 820, 840, and 860 of the WET band/sub-channel and the wireless information transmission (WIT) band/sub-channel. FIG. 8A illustrates a first example 800 including a dedicated WET band/sub-channel 802 and a dedicated WIT band/sub-channel 804. In one aspect, the WET band/sub-channel 802 and the WIT band/sub-channel 804 may be TDDed. That is, the WET band/sub-channel 802 and the WIT band/sub-channel 804 may be separated in time by a time gap 806 (which may be referred to as time-divisioned), and the transmission of the WET band/sub-channel 802 and the transmission of the WIT band/sub-channel 804 may not overlap each other in the time-domain.

FIG. 8B illustrates a second example 820 including a dedicated WET band 822 and a dedicated WIT band 824. Here, the WET band 822 and the WIT band 824 may be FDDed. That is, the WET band 822 and the WIT band 824 may be transmitted in different frequency bands. In one aspect, a duplex gap 826 may be configured between the WET band 822 and the WIT band 824 (e.g., in a per band manner). In one example, a UE supporting the WET operation may have different antennas configured for power harvesting from the WET band 822 and transmitting/receiving information in the WIT band 824.

In another aspect, the UL WIT band and the DL WIT band may be TDD. That is, the WET band 822 and the WIT band 824 may be FDDed with the duplex gap 826 in between, and the UL WIT band and the DL WIT band may be TDDed within the WIT band 824. That is, the UL WIT band and the DL WIT band may be configured to overlap in the frequency domain, but not overlap in the time domain (e.g., transmitted at a different time period).

FIG. 8C illustrates a third example 840 including a dedicated WET and DL WIT band 842 that may overlap with the DL WIT band, and a dedicated UL WIT band 844. Here, the WET band 842 may be used for communicating the DL channel including the DL signals, while the UL WIT band 844 may be used for the UL data transmission. A duplex gap 826 may be configured between the WET and DL WIT band 842 and the UL WIT band 824 (e.g., in a per band manner).

FIG. 8D illustrates a fourth example 860 including a dedicated WET band/sub-channel 862, a dedicated DL WIT band/sub-channel 866, and a dedicated UL WIT band/sub-channel 864. Here, a guard band 863 between the WET band/sub-channel 862 and the DL WIT band/sub-channel 866 for interference leakage from the WET band/sub-channel 862 into the DL WIT band/sub-channel 866. The guard band 863 may be configured small that the WET band/sub-channel 862 and the DL WIT band/sub-channel 866 may be communicated using the same antenna at the UE.

In another aspect, the WET band and the WIT band may be configured in different sub-channels in a same band. That is, a single band including multiple sub-channels may be configured with a first set of sub-channels configured as the WET sub-channels and a second set of sub-channels as the WIT sub-channels. At least one guard band may be defined between the WET sub-channel and the WIT sub-channels.

In one example, the DL WIT sub-channels and the UL WIT sub-channels may be FDDed. That is, the DL WIT sub-channels and the UL WIT sub-channels may be allocated in different sub-channels with a guard band in between. In another example, the DL WIT sub-channels and the UL WIT sub-channels may be TDDed. That is, the DL WIT sub-channels and the UL WIT sub-channels in the WIT sub-channels may overlap in the frequency domain but not overlap in the time domain (e.g., transmitted at a different time period).

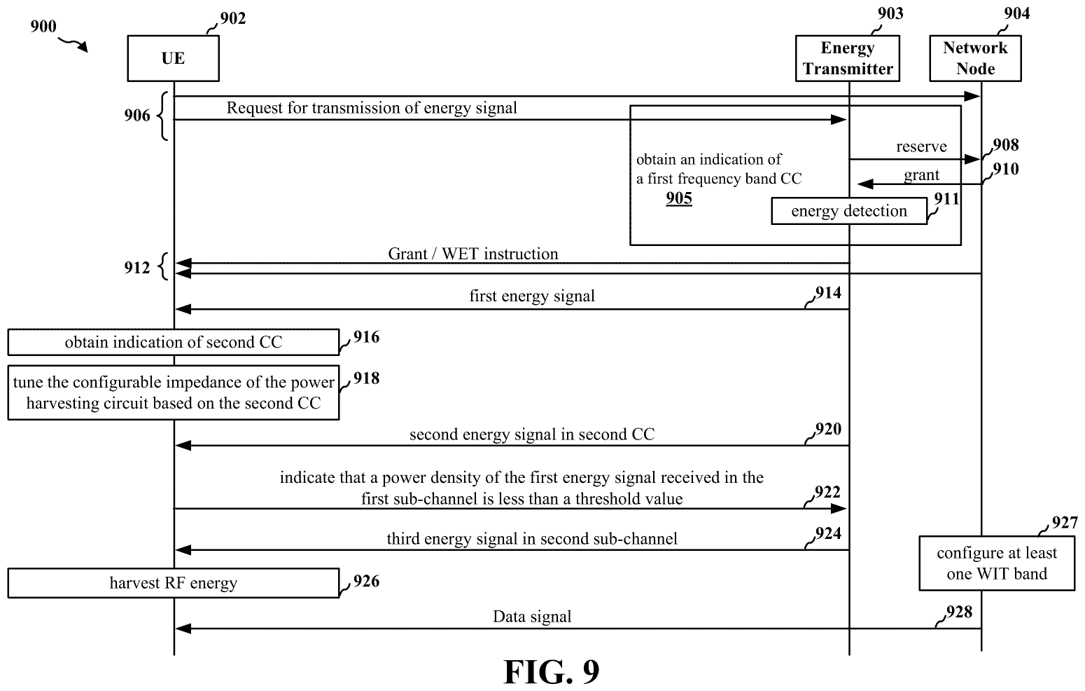

FIG. 9 is a call-flow diagram 900 of a method of wireless communication. The call-flow diagram 900 may include a UE 902, an energy transmitter 903, and a network node 904 configured to support a WET operation. Here, the UE 902 may be an energy receiver including a power harvesting circuit, and the energy transmitter 903 may be another UE or a network node (including the network node 904). In some aspects, a dedicated wireless energy transmission band or sub-channel may be configured and the energy transmitter 903 may be configured to transmit an energy signal to the UE 902 to turn on and communicate with the UE 902. The network node 904 may configure the at least one dedicated WET bands/sub-channels for the UE 902 and the energy transmitter 903. The energy transmitter 903 may transmit energy signal to the UE 902 on the at least one dedicated WET bands/sub-channels. The UE 902 may harvest RF energy from the energy signal received on the at least one dedicated WET bands/sub-channels using the power harvesting circuit, and communicate data signals with the network node 904.

The network node 904 may configure a first frequency band or a first CC dedicated for WET from one or more frequency bands or one or more CCs associated with the WET for a network entity to transmit a first energy signal in the first frequency band dedicated for the WET to the UE 902.

At 905, the energy transmitter 903 may obtain an indication of a first frequency band or a first CC dedicated for WET from one or more frequency bands or one or more CCs associated with the WET. Here, a guard band between the first frequency band dedicated for the WET, the first frequency band dedicated for the WET, or each sub-channel of the first frequency band dedicated for the WET may be configured. 907 may include 906, 908, 910, and 911.

At 906, the UE 902 may transmit a WET request to at least one network entity to transmit the first energy signal in the first frequency band. Here, the at least one network entity may be the energy transmitter 903 or the network node 904. The energy transmitter 903 may receive a WET request from the UE 902 to transmit the first energy signal. The network node 904 may receive a WET request from the UE 902. The grant to the network entity to transmit the first energy signal on the first frequency band may be transmitted based on the WET request received from the UE 902.

At 908, the energy transmitter 903 may transmit a message reserving the first frequency band for transmitting the first energy signal to the network node 904. In one aspect, the message reserving the first frequency band may be transmitted based on receiving the WET request from the UE 902 at 906. The network node 904 may receive a message reserving the first frequency band for transmitting the first energy signal from the energy transmitter 903.

At 910, the network node 904 may transmit a grant to transmit the first energy signal on the first frequency band from a network node 904. The energy transmitter 903 may receive a grant to transmit the first energy signal on the first frequency band from a network node 904. In one aspect, the grant may be received based on the message reserving the first frequency band transmitted to the network node 904 at 908. In another aspect, the grant may be based the WET request received from the UE 902 at 906.

At 911, the energy transmitter 903 may perform an energy detection in the first frequency band. Here, the first energy signal may be transmitted in the first frequency band at 914 based on an outcome of the energy detection in the first frequency band is less than or equal to a threshold value.

At 912, the network node 904 or the energy transmitter 903 may transmit a grant or WET instruction that the first energy signal is transmitted from the energy transmitter 903 to the UE 902. The UE 902 may receive a WET instruction to receive the first energy signal in the first frequency band from a network entity. Here, the network entity may include the energy transmitter 903 or the network node 904. The first energy signal may be received at 914 in the first frequency band based on the received WET instruction. The grant or the WET instruction may include at least one configuration of the first energy signal is based on the first frequency band. In one aspect, the at least one configuration of the first energy signal may include EIRP or PSD of the first energy signal.

At 914, the energy transmitter 903 may transmit a first energy signal in a first frequency band or a first CC dedicated for WET from one or more frequency bands or one or more CCs associated with the WET. The first energy signal may be transmitted in the first frequency band based on receiving the grant from the network node 904 at 910 or receiving the WET request from the UE 902 at 906. The UE 902 may receive a first energy signal in a first frequency band or a first CC dedicated for WET from one or more frequency bands or one or more CCs associated with the WET. The first energy signal may be received in the first frequency band based on the received WET request. In one aspect, the first CC may be dedicated for WET across multiple cells, and the one or more CCs associated with the WET may include at least one CC configured for WET in a particular cell. In another aspect, the first frequency band dedicated for the WET includes a plurality of sub-channels, and the first energy signal may be received in a first sub-channel of the plurality of sub-channels.

At 916, the UE 902 may obtain, within the first CC, an indication of a second CC of the one or more CCs associated with the WET. Here, the UE 902 may include a power harvesting circuit with a configurable impedance, and the configurable impedance may be configured based on the first frequency band dedicated for the WET. At 918, the UE 902 may tune the configurable impedance of the power harvesting circuit based on the second CC.

At 920, the energy transmitter 903 may transmit a second energy signal in the second frequency CC dedicated for WET from one or more CCs associated with the WET. The UE 902 may receive a second energy signal in the second CC dedicated for WET from one or more CCs associated with the WET.

At 922, the UE 902 may indicate that a power density of the first energy signal received in the first sub-channel is less than a threshold value. The energy transmitter 903 may receive an indication that a power density of the first energy signal received in the first sub-channel is less than a threshold value.

At 924, the energy transmitter 903 may transmit a third energy signal in a second sub-channel of the plurality of sub-channels. Here, the third energy signal in the second sub-channel of the plurality of sub-channels may be based on receiving the indication that the power density of the first energy signal received at the UE 902 in the first sub-channel is less than the threshold value at 922. The UE 902 may receive a third energy signal in a second sub-channel of the plurality of sub-channels. Here, the transmission of the third energy signal in the second sub-channel is based on the indication that the power density of the first energy signal received in the first sub-channel is less than the threshold value at 922.

At 926, the UE 902 may harvest RF energy from the first energy signal received at 914 based on receiving the first energy signal in the first frequency band dedicated for the WET or the second energy signal received at 920 using a power harvesting circuit based on receiving the second energy signal in the second CC dedicated for the WET.

In one aspect, the power harvesting circuit may have a configurable impedance configured based on the first frequency band dedicated for the WET, and in response to the UE 902 tuning the configurable impedance of the power harvesting circuit based on the second CC at 918, the UE 902 may harvest radio-frequency energy from a second energy signal received in the second CC using the power harvesting circuit having the configurable impedance tuned based on the second CC.

At 927, the network node 904 may configure at least one WIT band including one or more of a DL WIT band carrying a DL channel, an UL WIT band carrying an UL channel, or a SL WIT band carrying a SL channel for the UE 902 to communicate a data signal with the network node 904 or another UE 902.

At 928, the network node 904 and the UE 902 may communicate a data signal in a RAT band adjacent to the first frequency band in frequency domain. In one example, the RAT band may not be based on an ACLR caused by the data signal in the WET band. In another example, the at least one configuration of the first energy signal transmitted at 914 may be based on an ACLR caused by the first energy signal in the RAT band.

The RAT band may be configured to carry a data signal and a mitigating signal, the mitigating signal configured to reduce the ACLR caused by the data signal transmitted in the RAT band. The UE 902 may communicate data signal in at least one of a DL channel, an UL channel or a SL channel, and the at least one of the DL channel, the UL channel, or the SL channel may be communicated in at least one WIT band including one or more of a DL WIT band carrying the DL channel, an UL WIT band carrying the UL channel, or a SL WIT band carrying the SL channel. In one example, the first frequency band dedicated for the WET and the at least one WIT band may be TDDed. In another example, the first frequency band dedicated for the WET and the at least one WIT band may be FDDed.

In one aspect, a duplex gap may be configured between the first frequency band and the at least one WIT band, and the UE 902 may include a first antenna configured to receive the first frequency band dedicated for the WET and a second antenna configured to receive at least a part of the at least one WIT band.

In another aspect, the DL WIT band may overlap with the first frequency band in a frequency domain. A guard band may be configured between the first frequency band and the DL WIT band, and a duplex gap may be configured between the first frequency band and the UL WIT band, the duplex gap being greater than the guard band. In another aspect, the UL WIT band and the DL WIT band may be TDDed. In another aspect, the first frequency band may include a plurality of sub-channels, and the first energy signal may be received in a first sub-channel of the plurality of sub-channels, and the at least one WIT band may overlap with a second sub-channel of the plurality of sub-channels. The guard band may be configured between the first sub-channel and the second sub-channel, and the UL WIT band and the DL WIT band may be TDDed in the second sub-channel.

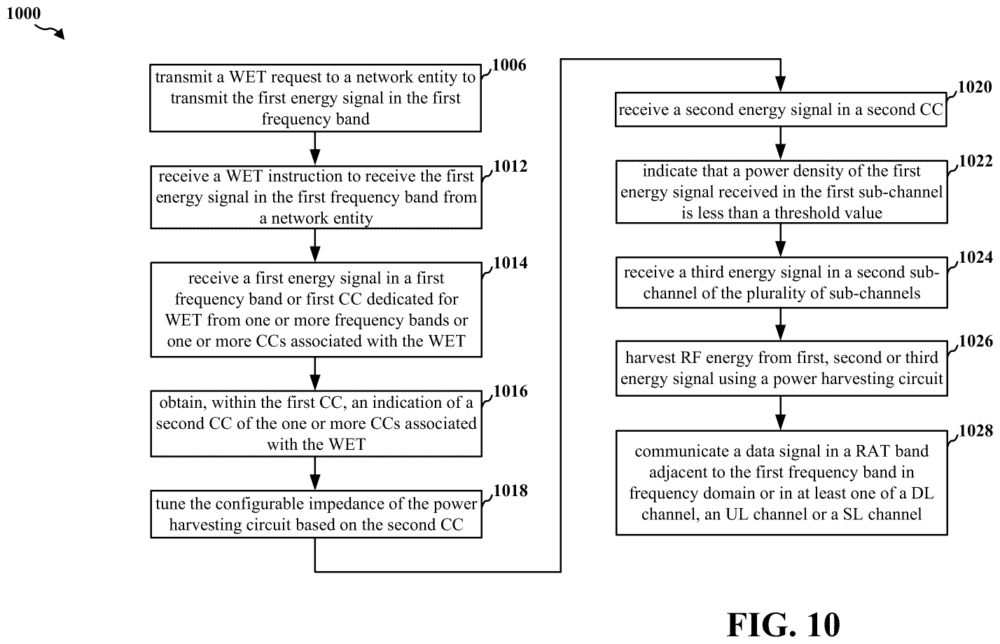

FIG. 10 is a flowchart 1000 of a method of wireless communication. The method may be performed by a UE (e.g., the UE 104/902; the apparatus 1604). According to the flowchart 1000, the UE, an energy transmitter, and a network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1006, the UE may transmit a WET request to at least one network entity to transmit the first energy signal in the first frequency band. Here, the at least one network entity may be the energy transmitter or the network node. For example, at 906, the UE 902 may transmit a WET request to at least one network entity to transmit the first energy signal in the first frequency band. Furthermore, 1006 may be performed by a wireless energy receiving component 198.

At 1012, the UE may receive a WET instruction to receive the first energy signal in the first frequency band from a network entity. Here, the network entity may include the energy transmitter or the network node. The first energy signal may be received at 1014 in the first frequency band based on the received WET instruction. The grant or the WET instruction may include at least one configuration of the first energy signal is based on the first frequency band. In one aspect, the at least one configuration of the first energy signal may include EIRP or PSD of the first energy signal. For example, at 912, the UE 902 may receive a WET instruction to receive the first energy signal in the first frequency band from a network entity. Furthermore, 1012 may be performed by the wireless energy receiving component 198.

At 1014, the UE may receive a first energy signal in a first frequency band or a first CC dedicated for WET from one or more frequency bands or one or more CCs associated with the WET. The first energy signal may be received in the first frequency band based on the received WET request. In one aspect, the first CC may be dedicated for WET across multiple cells, and the one or more CCs associated with the WET may include at least one CC configured for WET in a particular cell. In another aspect, the first frequency band dedicated for the WET includes a plurality of sub-channels, and the first energy signal may be received in a first sub-channel of the plurality of sub-channels. For example, at 914, the UE 902 may receive a first energy signal in a first frequency band or a first CC dedicated for WET from one or more frequency bands or one or more CCs associated with the WET. Furthermore, 1014 may be performed by the wireless energy receiving component 198.

At 1016, the UE may obtain, within the first CC, an indication of a second CC of the one or more CCs associated with the WET. Here, the UE may include a power harvesting circuit with a configurable impedance, and the configurable impedance may be configured based on the first frequency band dedicated for the WET. For example, at 916, the UE 902 may obtain, within the first CC, an indication of a second CC of the one or more CCs associated with the WET. Furthermore, 1016 may be performed by a wireless energy receiving component 198.

At 1018, the UE may tune the configurable impedance of the power harvesting circuit based on the second CC. For example, at 918, the UE 902 may tune the configurable impedance of the power harvesting circuit based on the second CC. Furthermore, 1018 may be performed by a wireless energy receiving component 198.

At 1020, the UE may receive a second energy signal in the second CC dedicated for WET from one or more CCs associated with the WET. For example, at 920, the UE 902 may receive a second energy signal in the second CC dedicated for WET from one or more CCs associated with the WET. Furthermore, 1020 may be performed by the wireless energy receiving component 198.

At 1022, the UE may indicate that a power density of the first energy signal received in the first sub-channel is less than a threshold value. For example, at 922, the UE 902 may indicate that a power density of the first energy signal received in the first sub-channel is less than a threshold value. Furthermore, 1022 may be performed by the wireless energy receiving component 198.

At 1024, the UE may receive a third energy signal in a second sub-channel of the plurality of sub-channels. Here, the transmission of the third energy signal in the second sub-channel is based on the indication that the power density of the first energy signal received in the first sub-channel is less than the threshold value at 1022. For example, at 924, the UE 902 may receive a third energy signal in a second sub-channel of the plurality of sub-channels. Furthermore, 1024 may be performed by the wireless energy receiving component 198.

At 1026, the UE may harvest RF energy from the first energy signal received at 1014 based on receiving the first energy signal in the first frequency band dedicated for the WET or the second energy signal received at 1020 using a power harvesting circuit based on receiving the second energy signal in the second CC dedicated for the WET. In one aspect, the power harvesting circuit may have a configurable impedance configured based on the first frequency band dedicated for the WET, and in response to the UE tuning the configurable impedance of the power harvesting circuit based on the second CC at 1018, the UE may harvest radio-frequency energy from a second energy signal received in the second CC using the power harvesting circuit having the configurable impedance tuned based on the second CC. For example, at 926, the UE 902 may harvest RF energy from the first energy signal received at 914 based on receiving the first energy signal in the first frequency band dedicated for the WET or the second energy signal received at 920 using a power harvesting circuit based on receiving the second energy signal in the second CC dedicated for the WET. Furthermore, 1026 may be performed by a wireless energy receiving component 198.

At 1028, the UE may communicate a data signal in a RAT band adjacent to the first frequency band in frequency domain with the network node. In one example, the RAT band may not be based on an ACLR caused by the data signal in the WET band. In another example, the at least one configuration of the first energy signal transmitted at 914 may be based on an ACLR caused by the first energy signal in the RAT band. For example, at 928, the UE 902 may communicate a data signal in a RAT band adjacent to the first frequency band in frequency domain with the network node 904. Furthermore, 1028 may be performed by the wireless energy receiving component 198.

The RAT band may be configured to carry a data signal and a mitigating signal, the mitigating signal configured to reduce the ACLR caused by the data signal transmitted in the RAT band. The UE may communicate data signal in at least one of a DL channel, an UL channel or a SL channel, and the at least one of the DL channel, the UL channel, or the SL channel may be communicated in at least one WIT band including one or more of a DL WIT band carrying the DL channel, an UL WIT band carrying the UL channel, or a SL WIT band carrying the SL channel. In one example, the first frequency band dedicated for the WET and the at least one WIT band may be TDDed. In another example, the first frequency band dedicated for the WET and the at least one WIT band may be FDDed.

In one aspect, a duplex gap may be configured between the first frequency band and the at least one WIT band, and the UE may include a first antenna configured to receive the first frequency band dedicated for the WET and a second antenna configured to receive at least a part of the at least one WIT band.

In another aspect, the DL WIT band may overlap with the first frequency band in a frequency domain. A guard band may be configured between the first frequency band and the DL WIT band, and a duplex gap may be configured between the first frequency band and the UL WIT band, the duplex gap being greater than the guard band. In another aspect, the UL WIT band and the DL WIT band may be TDDed. In another aspect, the first frequency band may include a plurality of sub-channels, and the first energy signal may be received in a first sub-channel of the plurality of sub-channels, and the at least one WIT band may overlap with a second sub-channel of the plurality of sub-channels. The guard band may be configured between the first sub-channel and the second sub-channel, and the UL WIT band and the DL WIT band may be TDDed in the second sub-channel.

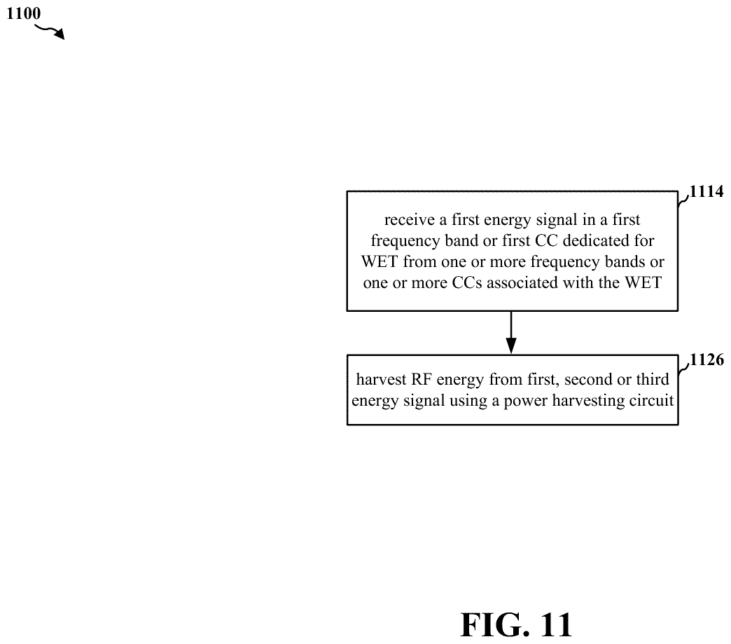

FIG. 11 is a flowchart 1100 of a method of wireless communication. The method may be performed by a UE (e.g., the UE 104/902; the apparatus 1604). According to the flowchart 1100, the UE, an energy transmitter, and a network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1114, the UE may receive a first energy signal in a first frequency band or a first CC dedicated for WET from one or more frequency bands or one or more CCs associated with the WET. The first energy signal may be received in the first frequency band based on the received WET request. In one aspect, the first CC may be dedicated for WET across multiple cells, and the one or more CCs associated with the WET may include at least one CC configured for WET in a particular cell. In another aspect, the first frequency band dedicated for the WET includes a plurality of sub-channels, and the first energy signal may be received in a first sub-channel of the plurality of sub-channels. For example, at 914, the UE 902 may receive a first energy signal in a first frequency band or a first CC dedicated for WET from one or more frequency bands or one or more CCs associated with the WET. Furthermore, 1114 may be performed by the wireless energy receiving component 198.

At 1126, the UE may harvest RF energy from the first energy signal received at 1114 based on receiving the first energy signal in the first frequency band dedicated for the WET or the second energy signal received at 1120 using a power harvesting circuit based on receiving the second energy signal in the second CC dedicated for the WET. In one aspect, the power harvesting circuit may have a configurable impedance configured based on the first frequency band dedicated for the WET, and in response to the UE tuning the configurable impedance of the power harvesting circuit based on the second CC at 1118, the UE may harvest radio-frequency energy from a second energy signal received in the second CC using the power harvesting circuit having the configurable impedance tuned based on the second CC. For example, at 926, the UE 902 may harvest RF energy from the first energy signal received at 914 based on receiving the first energy signal in the first frequency band dedicated for the WET or the second energy signal received at 920 using a power harvesting circuit based on receiving the second energy signal in the second CC dedicated for the WET. Furthermore, 1126 may be performed by a wireless energy receiving component 198.

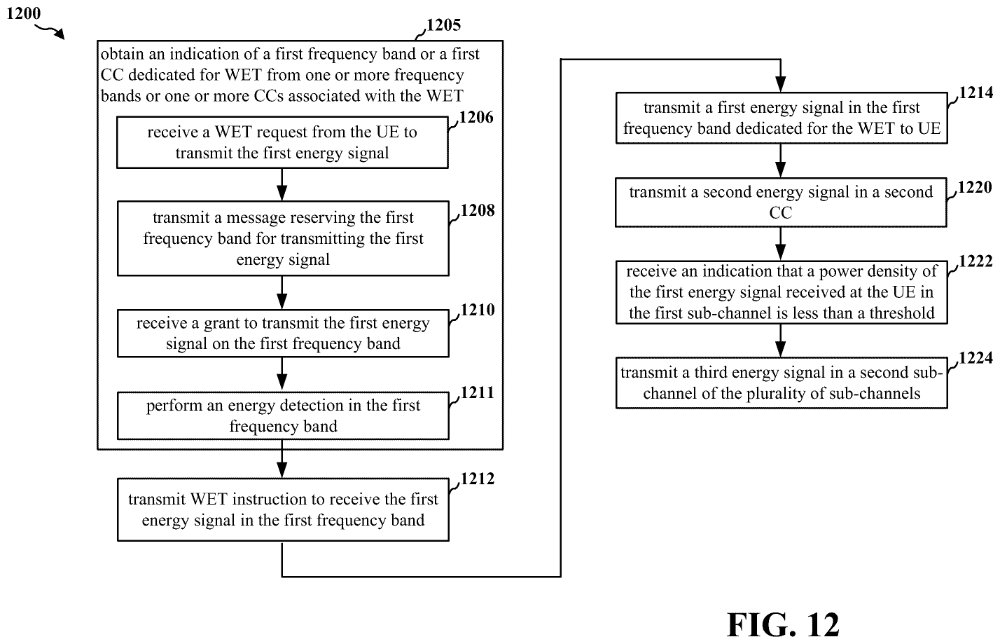

FIG. 12 is a flowchart 1200 of a method of wireless communication. The method may be performed by a wireless energy transmitter. The wireless energy transmitter may be a network entity including another UE or a network entity (e.g., the energy transmitter 903; the apparatus 1604; the network entity 1702). According to the flowchart 1200, a UE, the energy transmitter, and a network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1205, the wireless energy transmitter may obtain an indication of a first frequency band or a first CC dedicated for WET from one or more frequency bands or one or more CCs associated with the WET. Here, a guard band between the first frequency band dedicated for the WET, the first frequency band dedicated for the WET, or each sub-channel of the first frequency band dedicated for the WET may be configured. For example, at 905, the wireless energy transmitter may 904 may obtain an indication of a first frequency band or a first CC dedicated for WET from one or more frequency bands or one or more CCs associated with the WET. Furthermore, 1205 may be performed by a wireless energy transmitting component 199A. 1205 may include 1206, 1208, 1210, and 1211.

At 1206, the wireless energy transmitter may receive a WET request from the UE 902 to transmit the first energy signal. For example, at 906, the wireless energy transmitter may 904 may receive a WET request from the UE 902 to transmit the first energy signal. Furthermore, 1206 may be performed by a wireless energy transmitting component 199A.

At 1208, the wireless energy transmitter may transmit a message reserving the first frequency band for transmitting the first energy signal to the network node. In one aspect, the message reserving the first frequency band may be transmitted based on receiving the WET request from the UE at 1206. For example, at 908, the wireless energy transmitter may 904 may transmit a message reserving the first frequency band for transmitting the first energy signal to the network node 904. Furthermore, 1208 may be performed by the wireless energy transmitting component 199A.

At 1210, the wireless energy transmitter may receive a grant to transmit the first energy signal on the first frequency band from a network node. In one aspect, the grant may be received based on the message reserving the first frequency band transmitted to the network node at 1208. In another aspect, the grant may be based the WET request received from the UE at 1206. For example, at 910, the wireless energy transmitter may receive a grant to transmit the first energy signal on the first frequency band from a network node 904. Furthermore, 1210 may be performed by the wireless energy transmitting component 199A.

At 1211, the wireless energy transmitter may perform an energy detection in the first frequency band. Here, the first energy signal may be transmitted in the first frequency band at 914 based on an outcome of the energy detection in the first frequency band is less than or equal to a threshold value. For example, at 911, the wireless energy transmitter may 904 may perform an energy detection in the first frequency band. Furthermore, 1211 may be performed by the wireless energy transmitting component 199A.

At 1212, the wireless energy transmitter may transmit a grant or WET instruction that the first energy signal is transmitted from the energy transmitter to the UE. The first energy signal may be transmitted at 1214 in the first frequency band based on the received WET instruction. The grant or the WET instruction may include at least one configuration of the first energy signal is based on the first frequency band. In one aspect, the at least one configuration of the first energy signal may include EIRP or PSD of the first energy signal. For example, at 912, the wireless energy transmitter may 904 may transmit a grant or WET instruction that the first energy signal is transmitted from the energy transmitter 903 to the UE 902. Furthermore, 1212 may be performed by the wireless energy transmitting component 199A.

At 1214, the wireless energy transmitter may transmit a first energy signal in a first frequency band or a first CC dedicated for WET from one or more frequency bands or one or more CCs associated with the WET. The first energy signal may be transmitted in the first frequency band based on the grant received from the network node at 1210 or the WET request receiving from the UE at 1206. Here, the first CC may be dedicated for the WET across multiple cells, and the one or more CCs associated with the WET may include at least one CC configured for WET in a particular cell. For example, at 914, the wireless energy transmitter may 904 may transmit a first energy signal in a first frequency band or a first CC dedicated for WET from one or more frequency bands or one or more CCs associated with the WET. Furthermore, 1214 may be performed by the wireless energy transmitting component 199A.

The UE may receive a first energy signal in a first frequency band or a first CC dedicated for WET from one or more frequency bands or one or more CCs associated with the WET. The first energy signal may be transmitted in the first frequency band based on the received WET request. In one aspect, the first CC may be dedicated for WET across multiple cells, and the one or more CCs associated with the WET may include at least one CC configured for WET in a particular cell. In another aspect, the first frequency band dedicated for the WET includes a plurality of sub-channels, and the first energy signal may be received in a first sub-channel of the plurality of sub-channels.

At 1220, the wireless energy transmitter may transmit a second energy signal in the second frequency CC dedicated for WET from one or more CCs associated with the WET. For example, at 920, the wireless energy transmitter may 904 may transmit a second energy signal in the second frequency CC dedicated for WET from one or more CCs associated with the WET. Furthermore, 1220 may be performed by the wireless energy transmitting component 199A.

At 1222, the wireless energy transmitter may receive an indication that a power density of the first energy signal received in the first sub-channel is less than a threshold value. For example, at 922, the wireless energy transmitter may 904 may receive an indication that a power density of the first energy signal received in the first sub-channel is less than a threshold value. Furthermore, 1222 may be performed by the wireless energy transmitting component 199A.

At 1224, the wireless energy transmitter may transmit a third energy signal in a second sub-channel of the plurality of sub-channels. Here, the third energy signal in the second sub-channel of the plurality of sub-channels may be based on receiving the indication that the power density of the first energy signal received at the UE in the first sub-channel is less than the threshold value at 1222. For example, at 924, the wireless energy transmitter may 904 may transmit a third energy signal in a second sub-channel of the plurality of sub-channels. Furthermore, 1224 may be performed by the wireless energy transmitting component 199A.

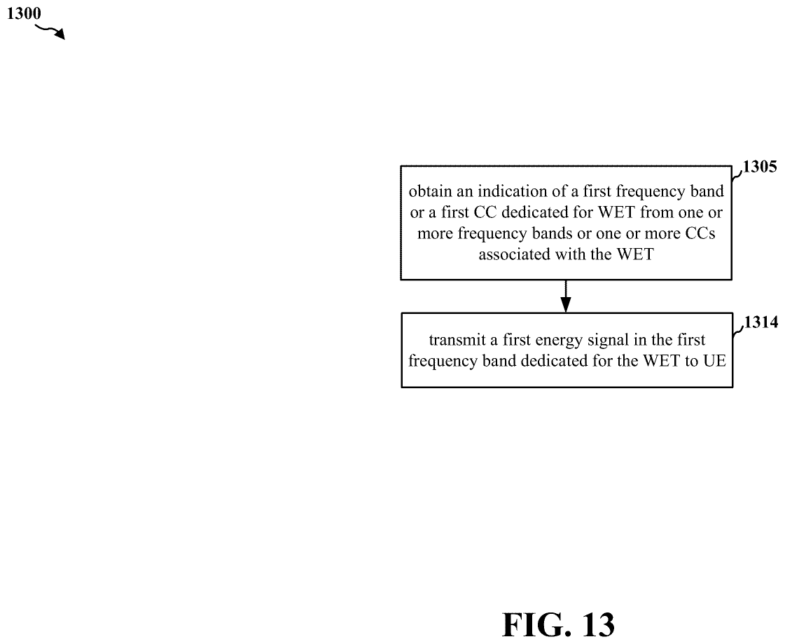

FIG. 13 is a flowchart 1300 of a method of wireless communication. The method may be performed by a wireless energy transmitter. The wireless energy transmitter may be a network entity including another UE or a network entity (e.g., the energy transmitter 903; the apparatus 1604; the network entity 1702). According to the flowchart 1300, a UE, the energy transmitter, and a network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1305, the wireless energy transmitter may obtain an indication of a first frequency band or a first CC dedicated for WET from one or more frequency bands or one or more CCs associated with the WET. Here, a guard band between the first frequency band dedicated for the WET, the first frequency band dedicated for the WET, or each sub-channel of the first frequency band dedicated for the WET may be configured. For example, at 905, the wireless energy transmitter may 904 may obtain an indication of a first frequency band or a first CC dedicated for WET from one or more frequency bands or one or more CCs associated with the WET. Furthermore, 1305 may be performed by a wireless energy transmitting component 199A.

At 1314, the wireless energy transmitter may transmit a first energy signal in a first frequency band or a first CC dedicated for WET from one or more frequency bands or one or more CCs associated with the WET. The first energy signal may be transmitted in the first frequency band based on the grant received from the network node at 1310 or the WET request receiving from the UE at 1306. Here, the first CC may be dedicated for the WET across multiple cells, and the one or more CCs associated with the WET may include at least one CC configured for WET in a particular cell. For example, at 914, the wireless energy transmitter may 904 may transmit a first energy signal in a first frequency band or a first CC dedicated for WET from one or more frequency bands or one or more CCs associated with the WET. Furthermore, 1314 may be performed by the wireless energy transmitting component 199A.

The UE may receive a first energy signal in a first frequency band or a first CC dedicated for WET from one or more frequency bands or one or more CCs associated with the WET. The first energy signal may be transmitted in the first frequency band based on the received WET request. In one aspect, the first CC may be dedicated for WET across multiple cells, and the one or more CCs associated with the WET may include at least one CC configured for WET in a particular cell. In another aspect, the first frequency band dedicated for the WET includes a plurality of sub-channels, and the first energy signal may be received in a first sub-channel of the plurality of sub-channels.

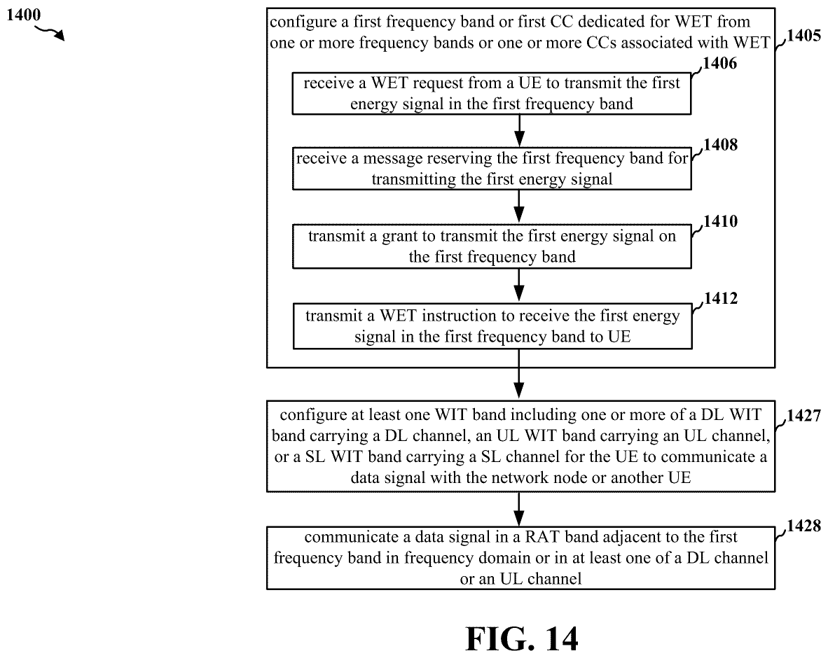

FIG. 14 is a flowchart 1400 of a method of wireless communication. The method may be performed by a network node (e.g., the base station 102; the network entity 1702). According to the flowchart 1400, a UE, an energy transmitter, and the network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1405, the network node may configure a first frequency band or a first CC dedicated for WET from one or more frequency bands or one or more CCs associated with the WET for a network entity to transmit a first energy signal in the first frequency band dedicated for the WET to a UE. For example, at 905, the network node 904 may configure a first frequency band or a first CC dedicated for WET from one or more frequency bands or one or more CCs associated with the WET for a network entity to transmit a first energy signal in the first frequency band dedicated for the WET to a UE. Furthermore, 1405 may be performed by a wireless energy transmission configuring component 199B. 1405 may include 1406, 1408, 1410, and 1412.

At 1406, the network node may receive a WET request from the UE. The grant to the network entity to transmit the first energy signal on the first frequency band may be transmitted based on the WET request received from the UE. For example, at 906, the network node 904 may receive a WET request from the UE 902. Furthermore, 1406 may be performed by a wireless energy transmission configuring component 199B.

At 1408, the network node may receive a message reserving the first frequency band for transmitting the first energy signal from the energy transmitter 903. In one aspect, the message reserving the first frequency band may be received based on the WET request transmitted from the UE. For example, at 908, the network node 904 may receive a message reserving the first frequency band for transmitting the first energy signal from the energy transmitter. Furthermore, 1408 may be performed by the wireless energy transmission configuring component 199B.

At 1410, the network node may transmit a grant to transmit the first energy signal on the first frequency band from a network node. In one aspect, the grant may be received based on the message reserving the first frequency band transmitted to the network node at 1408. In another aspect, the grant may be based the WET request received from the UE at 1406. For example, at 910, the network node 904 may transmit a grant to transmit the first energy signal on the first frequency band from a network node 904. Furthermore, 1410 may be performed by the wireless energy transmission configuring component 199B.

At 1412, the network node may transmit a grant or WET instruction that the first energy signal is transmitted from the energy transmitter to the UE. The first energy signal may be transmitted by the energy transmitter in the first frequency band based on the WET instruction transmitted to the UE. The grant or the WET instruction may include at least one configuration of the first energy signal is based on the first frequency band. In one aspect, the at least one configuration of the first energy signal may include EIRP or PSD of the first energy signal. For example, at 912, the network node 904 may transmit a grant or WET instruction that the first energy signal is transmitted from the energy transmitter 903 to the UE 902. Furthermore, 1412 may be performed by the wireless energy transmission configuring component 199B.

At 1427, the network node may configure at least one WIT band including one or more of a DL WIT band carrying a DL channel, an UL WIT band carrying an UL channel, or a SL WIT band carrying a SL channel for the UE to communicate a data signal with the network node or another UE. For example, at 927, the network node 904 may configure at least one WIT band including one or more of a DL WIT band carrying a DL channel, an UL WIT band carrying an UL channel, or a SL WIT band carrying a SL channel for the UE 902 to communicate a data signal with the network node 904 or another UE 902. Furthermore, 1427 may be performed by the wireless energy transmission configuring component 199B.

At 1428, the network node may communicate a data signal in a RAT band adjacent to the first frequency band in frequency domain with the UE. In one example, the RAT band may not be based on an ACLR caused by the data signal in the WET band. In another example, the at least one configuration of the first energy signal transmitted may be based on an ACLR caused by the first energy signal in the RAT band. For example, at 928, the network node 904 may communicate a data signal in a RAT band adjacent to the first frequency band in frequency domain with the UE 902. Furthermore, 1428 may be performed by the wireless energy transmission configuring component 199B.

The RAT band may be configured to carry a data signal and a mitigating signal, the mitigating signal configured to reduce the ACLR caused by the data signal transmitted in the RAT band. The UE 902 may communicate data signal in at least one of a DL channel, an UL channel or a SL channel, and the at least one of the DL channel, the UL channel, or the SL channel may be communicated in at least one WIT band including one or more of a DL WIT band carrying the DL channel, an UL WIT band carrying the UL channel, or a SL WIT band carrying the SL channel. In one example, the first frequency band dedicated for the WET and the at least one WIT band may be TDDed. In another example, the first frequency band dedicated for the WET and the at least one WIT band may be FDDed.

In one aspect, a duplex gap may be configured between the first frequency band and the at least one WIT band, and the UE may include a first antenna configured to receive the first frequency band dedicated for the WET and a second antenna configured to receive at least a part of the at least one WIT band.

In another aspect, the DL WIT band may overlap with the first frequency band in a frequency domain. A guard band may be configured between the first frequency band and the DL WIT band, and a duplex gap may be configured between the first frequency band and the UL WIT band, the duplex gap being greater than the guard band. In another aspect, the UL WIT band and the DL WIT band may be TDDed. In another aspect, the first frequency band may include a plurality of sub-channels, and the first energy signal may be received in a first sub-channel of the plurality of sub-channels, and the at least one WIT band may overlap with a second sub-channel of the plurality of sub-channels. The guard band may be configured between the first sub-channel and the second sub-channel, and the UL WIT band and the DL WIT band may be TDDed in the second sub-channel.

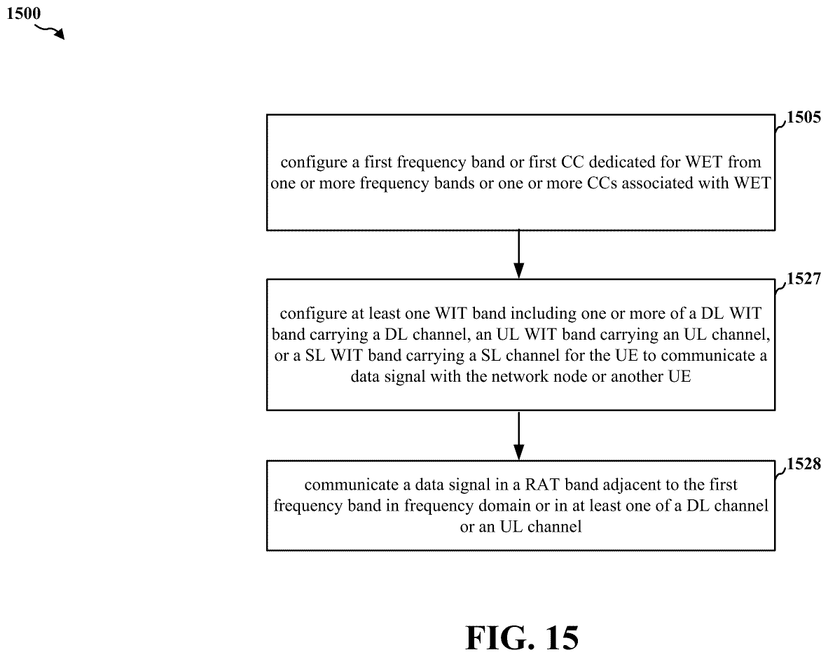

FIG. 15 is a flowchart 1500 of a method of wireless communication. The method may be performed by a network node (e.g., the base station 102; the network entity 1702). According to the flowchart 1500, a UE, an energy transmitter, and the network node may be configured to support a WET operation. Here, the UE may be an energy receiver including a power harvesting circuit, and the energy transmitter may be another UE or a network node. In some aspects, a dedicated wireless energy transmission band or sub-channel may be configured and the energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node.

At 1505, the network node may configure a first frequency band or a first CC dedicated for WET from one or more frequency bands or one or more CCs associated with the WET for a network entity to transmit a first energy signal in the first frequency band dedicated for the WET to a UE. For example, at 905, the network node 904 may configure a first frequency band or a first CC dedicated for WET from one or more frequency bands or one or more CCs associated with the WET for a network entity to transmit a first energy signal in the first frequency band dedicated for the WET to a UE. Furthermore, 1505 may be performed by a wireless energy transmission configuring component 199B.

At 1527, the network node may configure at least one WIT band including one or more of a DL WIT band carrying a DL channel, an UL WIT band carrying an UL channel, or a SL WIT band carrying a SL channel for the UE to communicate a data signal with the network node or another UE. For example, at 927, the network node 904 may configure at least one WIT band including one or more of a DL WIT band carrying a DL channel, an UL WIT band carrying an UL channel, or a SL WIT band carrying a SL channel for the UE 902 to communicate a data signal with the network node 904 or another UE 902. Furthermore, 1527 may be performed by the wireless energy transmission configuring component 199B.

At 1528, the network node may communicate a data signal in a RAT band adjacent to the first frequency band in frequency domain with the UE. In one example, the RAT band may not be based on an ACLR caused by the data signal in the WET band. In another example, the at least one configuration of the first energy signal transmitted may be based on an ACLR caused by the first energy signal in the RAT band. For example, at 928, the network node 904 may communicate a data signal in a RAT band adjacent to the first frequency band in frequency domain with the UE 902. Furthermore, 1528 may be performed by the wireless energy transmission configuring component 199B.

The RAT band may be configured to carry a data signal and a mitigating signal, the mitigating signal configured to reduce the ACLR caused by the data signal transmitted in the RAT band. The UE 902 may communicate data signal in at least one of a DL channel, an UL channel or a SL channel, and the at least one of the DL channel, the UL channel, or the SL channel may be communicated in at least one WIT band including one or more of a DL WIT band carrying the DL channel, an UL WIT band carrying the UL channel, or a SL WIT band carrying the SL channel. In one example, the first frequency band dedicated for the WET and the at least one WIT band may be TDDed. In another example, the first frequency band dedicated for the WET and the at least one WIT band may be FDDed.

In one aspect, a duplex gap may be configured between the first frequency band and the at least one WIT band, and the UE may include a first antenna configured to receive the first frequency band dedicated for the WET and a second antenna configured to receive at least a part of the at least one WIT band.

In another aspect, the DL WIT band may overlap with the first frequency band in a frequency domain. A guard band may be configured between the first frequency band and the DL WIT band, and a duplex gap may be configured between the first frequency band and the UL WIT band, the duplex gap being greater than the guard band. In another aspect, the UL WIT band and the DL WIT band may be TDDed. In another aspect, the first frequency band may include a plurality of sub-channels, and the first energy signal may be received in a first sub-channel of the plurality of sub-channels, and the at least one WIT band may overlap with a second sub-channel of the plurality of sub-channels. The guard band may be configured between the first sub-channel and the second sub-channel, and the UL WIT band and the DL WIT band may be TDDed in the second sub-channel.

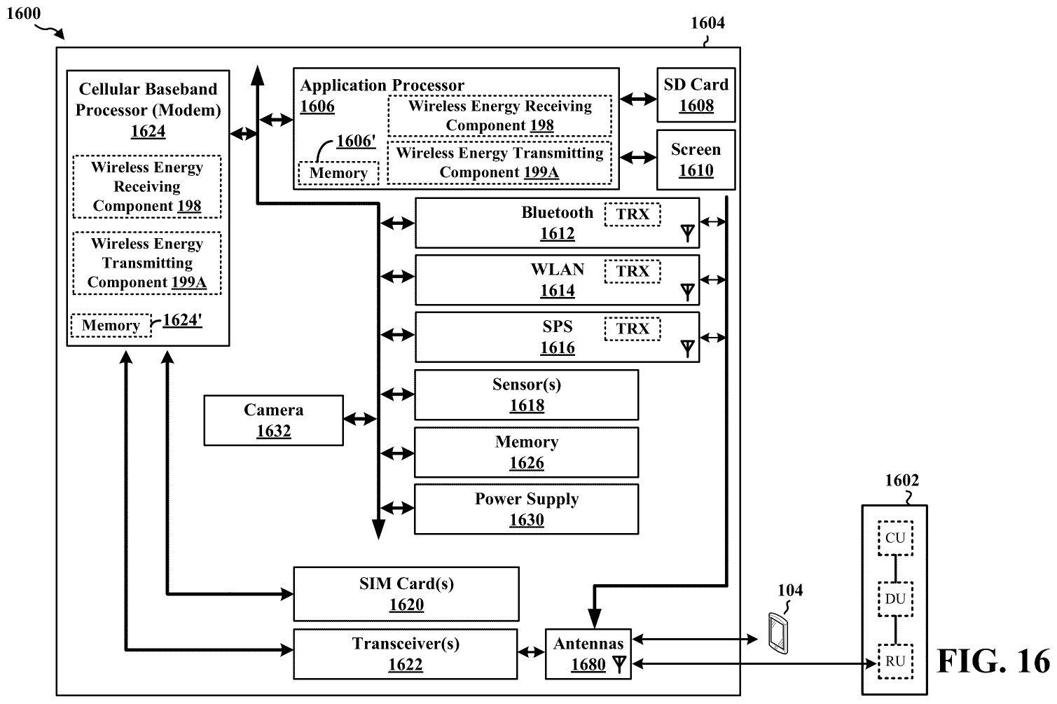

FIG. 16 is a diagram 1600 illustrating an example of a hardware implementation for an apparatus 1604. The apparatus 1604 may be a UE, a component of a UE, or may implement UE functionality. The apparatus 1604 may be the UE 902 or the energy transmitter 903. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the wireless energy receiving component 198 is configured to receive a first energy signal in a first frequency band or a first CC dedicated for WET from one or more frequency bands or one or more CCs associated with the WET, and harvest radio-frequency energy from the first energy signal using a power harvesting circuit based on receiving the first energy signal in the first frequency band dedicated for the WET. The wireless energy receiving component 198 may be within the cellular baseband processor 1624, the application processor 1606, or both the cellular baseband processor 1624 and the application processor 1606. The wireless energy receiving component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving a first energy signal in a first frequency band or a first CC dedicated for WET from one or more frequency bands or one or more CCs associated with the WET, and means for harvesting radio-frequency energy from the first energy signal using a power harvesting circuit based on receiving the first energy signal in the first frequency band dedicated for the WET. In one configuration, the power harvesting circuit has a configurable impedance configured based on the first frequency band dedicated for the WET. In one configuration, the apparatus 1604, and in particular the cellular baseband processor 1624 and/or the application processor 1606, further includes means for obtaining, within the first CC, an indication of a second CC of the one or more CCs associated with the WET, means for tuning the configurable impedance of the power harvesting circuit based on the second CC, and means for harvesting radio-frequency energy from a second energy signal received in the second CC using the power harvesting circuit having the configurable impedance tuned based on the second CC. In one configuration, the first CC is dedicated for WET across multiple cells, and the one or more CCs associated with the WET includes at least one CC configured for WET in a particular cell. In one configuration, the first frequency band dedicated for the WET includes a plurality of sub-channels, and the first energy signal is received in a first sub-channel of the plurality of sub-channels, and the apparatus 1604, and in particular the cellular baseband processor 1624 and/or the application processor 1606, further includes means for indicating that a power density of the first energy signal received in the first sub-channel is less than a threshold value. In one configuration, the apparatus 1604, and in particular the cellular baseband processor 1624 and/or the application processor 1606, further includes means for receiving a third energy signal in a second sub-channel of the plurality of sub-channels, based on the indication that the power density of the first energy signal received in the first sub-channel is less than the threshold value. In one configuration, at least one configuration of the first energy signal is based on the first frequency band. In one configuration, the at least one configuration of the first energy signal includes EIRP or PSD. In one configuration, the apparatus 1604, and in particular the cellular baseband processor 1624 and/or the application processor 1606, further includes means for communicating a data signal in a RAT band adjacent to the first frequency band in frequency domain, where the RAT band is not based on an ACLR caused by the data signal in the WET band. In one configuration, the apparatus 1604, and in particular the cellular baseband processor 1624 and/or the application processor 1606, further includes means for communicating a data signal in a RAT band adjacent to the first frequency band in frequency domain, where the at least one configuration of the first energy signal is based on an ACLR caused by the first energy signal in the RAT band. In one configuration, the RAT band is configured to carry a data signal and a mitigating signal, the mitigating signal configured to reduce the ACLR in the RAT band caused by the first energy signal transmitted in the first frequency domain. In one configuration, the apparatus 1604, and in particular the cellular baseband processor 1624 and/or the application processor 1606, further includes means for receiving a WET instruction to receive the first energy signal in the first frequency band from a network entity, where the first energy signal is received in the first frequency band based on the received WET instruction. In one configuration, the apparatus 1604, and in particular the cellular baseband processor 1624 and/or the application processor 1606, further includes means for transmitting a WET request to a network entity to transmit the first energy signal in the first frequency band, where the first energy signal is received in the first frequency band based on the received WET request. In one configuration, the apparatus 1604, and in particular the cellular baseband processor 1624 and/or the application processor 1606, further includes means for communicating data signal in at least one of a DL channel, an UL channel or a SL channel, where the at least one of the DL channel, the UL channel, or the SL channel is communicated in at least one WIT band including one or more of a DL WIT band carrying the DL channel, an UL WIT band carrying the UL channel, or a SL WIT band carrying the SL channel. In one configuration, the first frequency band dedicated for the WET and the at least one WIT band are TDD. In one configuration, the first frequency band dedicated for the WET and the at least one WIT band are FDD. In one configuration, a duplex gap is configured between the first frequency band and the at least one WIT band. In one configuration, the apparatus 1604, and in particular the cellular baseband processor 1624 and/or the application processor 1606, further includes a first antenna configured to receive the first frequency band dedicated for the WET, and a second antenna configured to receive at least a part of the at least one WIT band. In one configuration, the DL WIT band overlaps with the first frequency band in a frequency domain. In one configuration, a guard band is configured between the first frequency band and the DL WIT band, and a duplex gap is configured between the first frequency band and the UL WIT band, the duplex gap being greater than the guard band. In one configuration, the UL WIT band and the DL WIT band are TDD. In one configuration, the first frequency band includes a plurality of sub-channels, and the first energy signal is received in a first sub-channel of the plurality of sub-channels, and the at least one WIT band overlaps with a second sub-channel of the plurality of sub-channels. In one configuration, a guard band is configured between the first sub-channel and the second sub-channel. In one configuration, the UL WIT band and the DL WIT band are TDD in the second sub-channel. The means may be the wireless energy receiving component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the wireless energy transmitting component 199A is configured to obtain an indication of a first frequency band or a first CC dedicated for WET from one or more frequency bands or one or more CCs associated with the WET, and transmit a first energy signal in the first frequency band dedicated for the WET to a UE. The wireless energy transmitting component 199A may be within the cellular baseband processor 1624, the application processor 1606, or both the cellular baseband processor 1624 and the application processor 1606. The wireless energy transmitting component 199A may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for obtaining an indication of a first frequency band or a first CC dedicated for WET from one or more frequency bands or one or more CCs associated with the WET, and means for transmitting a first energy signal in the first frequency band dedicated for the WET to a UE. In one configuration, the means for obtaining the indication of the first frequency band dedicated for the WET is configured to receive a grant to transmit the first energy signal on the first frequency band from a network node, and the first energy signal is transmitted in the first frequency band based on receiving the grant from the network node. In one configuration, the means for obtaining the indication of the first frequency band dedicated for the WET is configured to transmit a message reserving the first frequency band for transmitting the first energy signal to the network node, and the grant is received based on the message reserving the first frequency band transmitted to the network node. In one configuration, the means for obtaining the indication of the first frequency band dedicated for the WET is configured to receive a WET request from the UE to transmit the first energy signal, and the first energy signal is transmitted in the first frequency band based on receiving the WET request from the UE. In one configuration, the means for obtaining the indication of the first frequency band dedicated for the WET is configured to perform an energy detection in the first frequency band, and the first energy signal is transmitted in the first frequency band based on an outcome of the energy detection in the first frequency band is less than or equal to a threshold value. In one configuration, the energy detection is performed in at least one of a guard band of the first frequency band dedicated for the WET, the first frequency band dedicated for the WET, or each sub-channel of the first frequency band dedicated for the WET. In one configuration, the apparatus 1604, and in particular the cellular baseband processor 1624 and/or the application processor 1606, further includes means for transmitting a second energy signal in a second CC, where the second CC of the one or more CCs is indicated based on the first CC. In one configuration, the first CC is dedicated for WET across multiple cells, and the one or more CCs associated with the WET includes at least one CC configured for WET in a particular cell. In one configuration, the first frequency band dedicate for the WET includes a plurality of sub-channels, and the first energy signal is received in a first sub-channel of the plurality of sub-channels, and the apparatus 1604, and in particular the cellular baseband processor 1624 and/or the application processor 1606, further includes means for receiving an indication that a power density of the first energy signal received at the UE in the first sub-channel is less than a threshold value. In one configuration, the apparatus 1604, and in particular the cellular baseband processor 1624 and/or the application processor 1606, further includes means for transmitting a third energy signal in a second sub-channel of the plurality of sub-channels based on receiving the indication that the power density of the first energy signal received at the UE in the first sub-channel is less than the threshold value. In one configuration, at least one configuration of the first energy signal is based on the first frequency band. In one configuration, the at least one configuration of the first energy signal includes EIRP or PSD. In one configuration, the at least one configuration of the first energy signal is based on an ACLR caused by the first energy signal in a RAT band carrying a data signal between the UE and a network node, the RAT band being adjacent to the first frequency band in frequency domain. In one configuration, the first frequency band dedicated for the WET and at least one WIT band are TDD, the at least one WIT band including one or more of a DL WIT band carrying a DL channel, an UL WIT band carrying an UL channel, or a SL WIT band carrying a SL channel for communicating a data signal between the UE and a network node or another UE. In one configuration, the first frequency band dedicated for the WET and at least one WIT band are FDD, the at least one WIT band including a DL WIT band carrying a DL channel and an UL WIT band carrying an UL channel for communicating a data signal between a network node and the UE. In one configuration, a duplex gap is configured between the first frequency band and the at least one WIT band. In one configuration, the DL WIT band overlaps with the first frequency band in a frequency domain. In one configuration, a guard band is configured between the first frequency band and the DL WIT band, and a duplex gap is configured between the first frequency band and the UL WIT band, the duplex gap being greater than the guard band. In one configuration, the first frequency band includes a plurality of sub-channels, and the first energy signal is received in a first sub-channel of the plurality of sub-channels, and at least one WIT band for communicating a data signal between a network node and the UE overlaps with a second sub-channel of the plurality of sub-channels. In one configuration, a guard band is configured between the first sub-channel and the second sub-channel. In one configuration, the at least one WIT band includes a DL WIT band carrying a DL channel and an UL WIT band carrying an UL channel for communicating the data signal between the network node and the UE, and the UL WIT band and the DL WIT band are TDD in the second sub-channel. The means may be the wireless energy transmitting component 199A of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

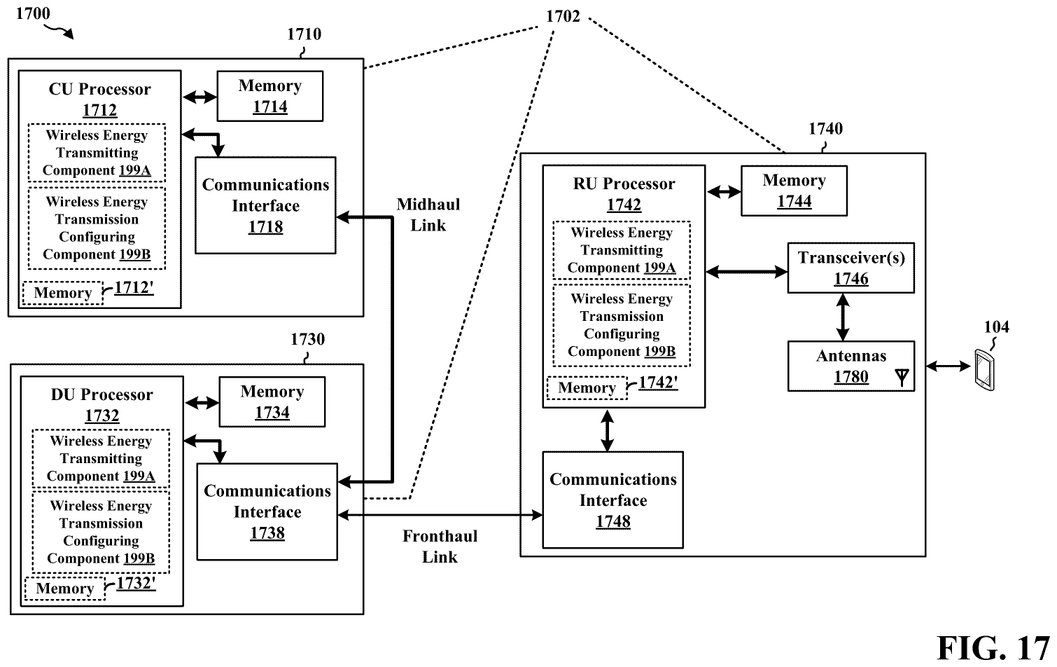

FIG. 17 is a diagram 1700 illustrating an example of a hardware implementation for a network entity 1702. The network entity 1702 may be a BS, a component of a BS, or may implement BS functionality. The network entity 1702 may be the energy transmitter 903 or the network node 904. The network entity 1702 may include at least one of a CU 1710, a DU 1730, or an RU 1740. For example, depending on the layer functionality handled by the wireless energy transmitting component 199A or the wireless energy transmission configuring component 199B, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the wireless energy transmitting component 199A is configured to obtain an indication of a first frequency band or a first CC dedicated for WET from one or more frequency bands or one or more CCs associated with the WET, and transmit a first energy signal in the first frequency band dedicated for the WET to a UE. The wireless energy transmitting component 199A may be within one or more processors of one or more of the CU 1710, DU 1730, and the RU 1740. The wireless energy transmitting component 199A may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for obtaining an indication of a first frequency band or a first CC dedicated for WET from one or more frequency bands or one or more CCs associated with the WET, and means for transmitting a first energy signal in the first frequency band dedicated for the WET to a UE. In one configuration, the means for obtaining the indication of the first frequency band dedicated for the WET is configured to receive a grant to transmit the first energy signal on the first frequency band from a network node, and the first energy signal is transmitted in the first frequency band based on receiving the grant from the network node. In one configuration, the means for obtaining the indication of the first frequency band dedicated for the WET is configured to transmit a message reserving the first frequency band for transmitting the first energy signal to the network node, and the grant is received based on the message reserving the first frequency band transmitted to the network node. In one configuration, the means for obtaining the indication of the first frequency band dedicated for the WET is configured to receive a WET request from the UE to transmit the first energy signal, and the first energy signal is transmitted in the first frequency band based on receiving the WET request from the UE. In one configuration, the means for obtaining the indication of the first frequency band dedicated for the WET is configured to perform an energy detection in the first frequency band, and the first energy signal is transmitted in the first frequency band based on an outcome of the energy detection in the first frequency band is less than or equal to a threshold value. In one configuration, the energy detection is performed in at least one of a guard band of the first frequency band dedicated for the WET, the first frequency band dedicated for the WET, or each sub-channel of the first frequency band dedicated for the WET. In one configuration, the network entity 1702 further includes means for transmitting a second energy signal in a second CC, where the second CC of the one or more CCs is indicated based on the first CC. In one configuration, the first CC is dedicated for WET across multiple cells, and the one or more CCs associated with the WET includes at least one CC configured for WET in a particular cell. In one configuration, the first frequency band dedicate for the WET includes a plurality of sub-channels, and the first energy signal is received in a first sub-channel of the plurality of sub-channels, and the network entity 1702 further includes means for receiving an indication that a power density of the first energy signal received at the UE in the first sub-channel is less than a threshold value. In one configuration, the network entity 1702 further includes means for transmitting a third energy signal in a second sub-channel of the plurality of sub-channels based on receiving the indication that the power density of the first energy signal received at the UE in the first sub-channel is less than the threshold value. In one configuration, at least one configuration of the first energy signal is based on the first frequency band. In one configuration, the at least one configuration of the first energy signal includes EIRP or PSD. In one configuration, the at least one configuration of the first energy signal is based on an ACLR caused by the first energy signal in a RAT band carrying a data signal between the UE and a network node, the RAT band being adjacent to the first frequency band in frequency domain. In one configuration, the first frequency band dedicated for the WET and at least one WIT band are TDD, the at least one WIT band including one or more of a DL WIT band carrying a DL channel, an UL WIT band carrying an UL channel, or a SL WIT band carrying a SL channel for communicating a data signal between the UE and a network node or another UE. In one configuration, the first frequency band dedicated for the WET and at least one WIT band are FDD, the at least one WIT band including a DL WIT band carrying a DL channel and an UL WIT band carrying an UL channel for communicating a data signal between a network node and the UE. In one configuration, a duplex gap is configured between the first frequency band and the at least one WIT band. In one configuration, the DL WIT band overlaps with the first frequency band in a frequency domain. In one configuration, a guard band is configured between the first frequency band and the DL WIT band, and a duplex gap is configured between the first frequency band and the UL WIT band, the duplex gap being greater than the guard band. In one configuration, the first frequency band includes a plurality of sub-channels, and the first energy signal is received in a first sub-channel of the plurality of sub-channels, and at least one WIT band for communicating a data signal between a network node and the UE overlaps with a second sub-channel of the plurality of sub-channels. In one configuration, a guard band is configured between the first sub-channel and the second sub-channel. In one configuration, the at least one WIT band includes a DL WIT band carrying a DL channel and an UL WIT band carrying an UL channel for communicating the data signal between the network node and the UE, and the UL WIT band and the DL WIT band are TDD in the second sub-channel. The means may be the wireless energy transmitting component 199A of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the wireless energy transmission configuring component 199B is configured to configure a first frequency band or a first CC dedicated for WET from one or more frequency bands or one or more CCs associated with the WET for a network entity to transmit a first energy signal in the first frequency band dedicated for the WET to a UE, configure at least one WIT band including one or more of a DL WIT band carrying a DL channel, an UL WIT band carrying an UL channel, or a SL WIT band carrying a SL channel for the UE to communicate a data signal with the network node or another UE, and communicate the data signal with the UE in the at least one WIT band. The wireless energy transmission configuring component 199B may be within one or more processors of one or more of the CU 1710, DU 1730, and the RU 1740. The wireless energy transmission configuring component 199B may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for configuring a first frequency band or a first CC dedicated for WET from one or more frequency bands or one or more CCs associated with the WET for a network entity to transmit a first energy signal in the first frequency band dedicated for the WET to a UE, means for configuring at least one WIT band including one or more of a DL WIT band carrying a DL channel, an UL WIT band carrying an UL channel, or a SL WIT band carrying a SL channel for the UE to communicate a data signal with the network node or another UE, and means for communicating the data signal with the UE in the at least one WIT band. In one configuration, the means for configuring the first frequency band dedicated for WET is configured to transmit a grant to the network entity to transmit the first energy signal on the first frequency band. In one configuration, the means for configuring the first frequency band dedicated for WET is configured to receive a message reserving the first frequency band for transmitting the first energy signal from the network entity, where the grant to the network entity to transmit the first energy signal on the first frequency band is transmitted based on the message reserving the first frequency band from the network entity. In one configuration, the first CC is dedicated for WET across multiple cells, and the one or more CCs associated with the WET includes at least one CC configured for WET in a particular cell. In one configuration, the first frequency band dedicated for the WET includes a plurality of sub-channels, and the first energy signal is received in a first sub-channel of the plurality of sub-channels. In one configuration, the first energy signal is configured based on the first frequency band. In one configuration, the at least one configuration of the first energy signal includes EIRP or PSD. In one configuration, the network entity 1702 further includes means for communicating a data signal in a RAT band adjacent to the first frequency band in frequency domain, where the RAT band is not based on an ACLR caused by the data signal in the WET band. In one configuration, the network entity 1702 further includes means for communicating a data signal in a RAT band adjacent to the first frequency band in frequency domain, where the first energy signal is configured based on an ACLR caused by the first energy signal in the RAT band. In one configuration, the RAT band is configured to carry a data signal and a mitigating signal, the mitigating signal configured to reduce the ACLR in the RAT band caused by the first energy signal transmitted in the first frequency domain. In one configuration, the network entity 1702 further includes means for communicating the data signal in at least one of a DL channel, an UL channel or a SL channel, where the at least one of the DL channel, the UL channel, or the SL channel is communicated in at least one WIT band including one or more of a DL WIT band carrying the DL channel, an UL WIT band carrying the UL channel, or a SL WIT band carrying the SL channel. In one configuration, the first frequency band dedicated for the WET and the at least one WIT band are TDD.

In one configuration, the first frequency band dedicated for the WET and the at least one WIT band are FDD. In one configuration, a duplex gap is configured between the first frequency band and the at least one WIT band. In one configuration, the DL WIT band overlaps with the first frequency band in a frequency domain. In one configuration, a guard band is configured between the first frequency band and the DL WIT band, and a duplex gap is configured between the first frequency band and the UL WIT band, the duplex gap being greater than the guard band. In one configuration, the UL WIT band and the DL WIT band are TDD. In one configuration, the first frequency band includes a plurality of sub-channels, and the first energy signal is received in a first sub-channel of the plurality of sub-channels, and the at least one WIT band overlaps with a second sub-channel of the plurality of sub-channels. In one configuration, a guard band is configured between the first sub-channel and the second sub-channel. In one configuration, the UL WIT band and the DL WIT band are TDD in the second sub-channel. The means may be the wireless energy transmission configuring component 199B of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

Based on some aspects of the current disclosure, a dedicated wireless energy transmission band or sub-channel may be configured for a UE, an energy transmitter, and a network node that may support WET operation. The energy transmitter may be configured to transmit an energy signal to the UE to turn on and communicate with the UE. The network node may configure the at least one dedicated WET bands/sub-channels for the UE and the energy transmitter. The energy transmitter may transmit energy signal to the UE on the at least one dedicated WET bands/sub-channels. The UE may harvest RF energy from the energy signal received on the at least one dedicated WET bands/sub-channels using the power harvesting circuit, and communicate data signals with the network node. In one aspect, the UE may be configured to receive a first energy signal in a first frequency band or a first CC dedicated for WET from one or more frequency bands or one or more CCs associated with the WET, and harvest radio-frequency energy from the first energy signal using a power harvesting circuit based on receiving the first energy signal in the first frequency band dedicated for the WET. In another aspect, the energy transmitter may be configured to obtain an indication of a first frequency band or a first CC dedicated for WET from one or more frequency bands or one or more CCs associated with the WET, and transmit a first energy signal in the first frequency band dedicated for the WET to a UE. In another aspect, the network entity may be configured to configure a first frequency band or a first CC dedicated for WET from one or more frequency bands or one or more CCs associated with the WET for a network entity to transmit a first energy signal in the first frequency band dedicated for the WET to a UE, configure at least one WIT band including one or more of a DL WIT band carrying a DL channel, an UL WIT band carrying an UL channel, or a SL WIT band carrying a SL channel for the UE to communicate a data signal with the network node or another UE, and communicate the data signal with the UE in the at least one WIT band.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a first energy signal in a first frequency band or a first CC dedicated for WET from one or more frequency bands or one or more CCs associated with the WET, and harvesting radio-frequency energy from the first energy signal using a power harvesting circuit based on receiving the first energy signal in the first frequency band dedicated for the WET.

Aspect 2 is the method of aspect 1, where the power harvesting circuit has a configurable impedance configured based on the first frequency band dedicated for the WET.

Aspect 3 is the method of any of aspects 1 and 2, further including obtaining, within the first CC, an indication of a second CC of the one or more CCs associated with the WET, tuning the configurable impedance of the power harvesting circuit based on the second CC, and harvesting radio-frequency energy from a second energy signal received in the second CC using the power harvesting circuit having the configurable impedance tuned based on the second CC.

Aspect 4 is the method of any of aspects 1 to 3, where the first CC is dedicated for WET across multiple cells, and the one or more CCs associated with the WET includes at least one CC configured for WET in a particular cell.

Aspect 5 is the method of any of aspects 1 to 4, where the first frequency band dedicated for the WET includes a plurality of sub-channels, and the first energy signal is received in a first sub-channel of the plurality of sub-channels, and further including indicating that a power density of the first energy signal received in the first sub-channel is less than a threshold value.

Aspect 6 is the method of aspect 5, further including receiving a third energy signal in a second sub-channel of the plurality of sub-channels, based on the indication that the power density of the first energy signal received in the first sub-channel is less than the threshold value.

Aspect 7 is the method of any of aspects 1 to 6, where at least one configuration of the first energy signal is based on the first frequency band.

Aspect 8 is the method of aspect 7, where the at least one configuration of the first energy signal includes EIRP or PSD.

Aspect 9 is the method of any of aspects 7 and 8, further including communicating a data signal in a RAT band adjacent to the first frequency band in frequency domain, where the RAT band is not based on an ACLR caused by the data signal in the WET band.

Aspect 10 is the method of any of aspects 7 to 9, further including communicating a data signal in a RAT band adjacent to the first frequency band in frequency domain, where the at least one configuration of the first energy signal is based on an ACLR caused by the first energy signal in the RAT band.

Aspect 11 is the method of aspect 10, where the RAT band is configured to carry a data signal and a mitigating signal, the mitigating signal configured to reduce the ACLR in the RAT band caused by the first energy signal transmitted in the first frequency domain.

Aspect 12 is the method of any of aspects 1 to 11, further including receiving a WET instruction to receive the first energy signal in the first frequency band from a network entity, where the first energy signal is received in the first frequency band based on the received WET instruction.

Aspect 13 is the method of any of aspects 1 to 12, further including transmitting a WET request to a network entity to transmit the first energy signal in the first frequency band, where the first energy signal is received in the first frequency band based on the received WET request.

Aspect 14 is the method of any of aspects 1 to 13, further including communicating data signal in at least one of a DL channel, an UL channel or a SL channel, where the at least one of the DL channel, the UL channel, or the SL channel is communicated in at least one WIT band including one or more of a DL WIT band carrying the DL channel, an UL WIT band carrying the UL channel, or a SL WIT band carrying the SL channel.

Aspect 15 is the method of aspect 14, where the first frequency band dedicated for the WET and the at least one WIT band are TDD.

Aspect 16 is the method of any of aspects 14 and 15, where the first frequency band dedicated for the WET and the at least one WIT band are FDD.

Aspect 17 is the method of aspect 16, where a duplex gap is configured between the first frequency band and the at least one WIT band.

Aspect 18 is the method of any of aspects 16 and 17, where the UE includes a first antenna configured to receive the first frequency band dedicated for the WET, and a second antenna configured to receive at least a part of the at least one WIT band.

Aspect 19 is the method of any of aspects 16 to 18, where the DL WIT band overlaps with the first frequency band in a frequency domain.

Aspect 20 is the method of any of aspects 16 to 19, where a guard band is configured between the first frequency band and the DL WIT band, and a duplex gap is configured between the first frequency band and the UL WIT band, the duplex gap being greater than the guard band.

Aspect 21 is the method of any of aspects 16 to 20, where the UL WIT band and the DL WIT band are TDD.

Aspect 22 is the method of any of aspects 14 to 21, where the first frequency band includes a plurality of sub-channels, and the first energy signal is received in a first sub-channel of the plurality of sub-channels, and the at least one WIT band overlaps with a second sub-channel of the plurality of sub-channels.

Aspect 23 is the method of aspect 22, where a guard band is configured between the first sub-channel and the second sub-channel.

Aspect 24 is the method of any of aspects 22 and 23, where the UL WIT band and the DL WIT band are TDD in the second sub-channel.

Aspect 25 is an apparatus for wireless communication including at least one processor coupled to a memory and configured to implement any of aspects 1 to 24, further including a transceiver coupled to the at least one processor.

Aspect 26 is an apparatus for wireless communication including means for implementing any of aspects 1 to 24.

Aspect 27 is a non-transitory computer-readable medium storing computer executable code, where the code when executed by a processor causes the processor to implement any of aspects 1 to 24.

Aspect 28 is a method of wireless communication at a UE, including obtaining an indication of a first frequency band or a first CC dedicated for WET from one or more frequency bands or one or more CCs associated with the WET, and transmitting a first energy signal in the first frequency band dedicated for the WET to a UE.

Aspect 29 is the method of aspect 28, where the obtaining the indication of the first frequency band dedicated for the WET includes receiving a grant to transmit the first energy signal on the first frequency band from a network node, where the first energy signal is transmitted in the first frequency band based on receiving the grant from the network node.

Aspect 30 is the method of aspect 29, where the obtaining the indication of the first frequency band dedicated for the WET includes transmitting a message reserving the first frequency band for transmitting the first energy signal to the network node, where the grant is received based on the message reserving the first frequency band transmitted to the network node.

Aspect 31 is the method of any of aspects 28 to 30, where the obtaining the indication of the first frequency band dedicated for the WET includes receiving a WET request from the UE to transmit the first energy signal, where the first energy signal is transmitted in the first frequency band based on receiving the WET request from the UE.

Aspect 32 is the method of any of aspects 28 to 31, where the obtaining the indication of the first frequency band dedicated for the WET includes performing an energy detection in the first frequency band, where the first energy signal is transmitted in the first frequency band based on an outcome of the energy detection in the first frequency band is less than or equal to a threshold value.

Aspect 33 is the method of aspect 32, where the energy detection is performed in at least one of a guard band of the first frequency band dedicated for the WET, the first frequency band dedicated for the WET, or each sub-channel of the first frequency band dedicated for the WET.

Aspect 34 is the method of any of aspects 28 to 33, further including transmitting a second energy signal in a second CC, where the second CC of the one or more CCs is indicated based on the first CC.

Aspect 35 is the method of any of aspects 28 to 34, where the first CC is dedicated for WET across multiple cells, and the one or more CCs associated with the WET includes at least one CC configured for WET in a particular cell.

Aspect 36 is the method of any of aspects 28 to 35, where the first frequency band dedicate for the WET includes a plurality of sub-channels, and the first energy signal is received in a first sub-channel of the plurality of sub-channels, and further including receiving an indication that a power density of the first energy signal received at the UE in the first sub-channel is less than a threshold value.

Aspect 37 is the method of aspect 36, further including transmitting a third energy signal in a second sub-channel of the plurality of sub-channels based on receiving the indication that the power density of the first energy signal received at the UE in the first sub-channel is less than the threshold value.

Aspect 38 is the method of any of aspects 28 to 37, where at least one configuration of the first energy signal is based on the first frequency band.

Aspect 39 is the method of aspect 38, where the at least one configuration of the first energy signal includes EIRP or PSD.

Aspect 40 is the method of any of aspects 38 and 39, where the at least one configuration of the first energy signal is based on an ACLR caused by the first energy signal in a RAT band carrying a data signal between the UE and a network node, the RAT band being adjacent to the first frequency band in frequency domain.

Aspect 41 is the method of any of aspects 28 to 40, where the first frequency band dedicated for the WET and at least one WIT band are TDD, the at least one WIT band including one or more of a DL WIT band carrying a DL channel, an UL WIT band carrying an UL channel, or a SL WIT band carrying a SL channel for communicating a data signal between the UE and a network node or another UE.

Aspect 42 is the method of any of aspects 28 to 41, where the first frequency band dedicated for the WET and at least one WIT band are FDD, the at least one WIT band including a DL WIT band carrying a DL channel and an UL WIT band carrying an UL channel for communicating a data signal between a network node and the UE.

Aspect 43 is the method of aspect 42, where a duplex gap is configured between the first frequency band and the at least one WIT band.

Aspect 44 is the method of any of aspects 42 and 43, where the DL WIT band overlaps with the first frequency band in a frequency domain.

Aspect 45 is the method of any of aspects 42 to 44 where a guard band is configured between the first frequency band and the DL WIT band, and a duplex gap is configured between the first frequency band and the UL WIT band, the duplex gap being greater than the guard band.

Aspect 46 is the method of any of aspects 28 to 45, where the first frequency band includes a plurality of sub-channels, and the first energy signal is received in a first sub-channel of the plurality of sub-channels, and at least one WIT band for communicating a data signal between a network node and the UE overlaps with a second sub-channel of the plurality of sub-channels.

Aspect 47 is the method of aspect 46, where a guard band is configured between the first sub-channel and the second sub-channel.

Aspect 48 is the method of any of aspects 46 and 47, where the at least one WIT band includes a DL WIT band carrying a DL channel and an UL WIT band carrying an UL channel for communicating the data signal between the network node and the UE, where the UL WIT band and the DL WIT band are TDD in the second sub-channel.

Aspect 49 is an apparatus for wireless communication including at least one processor coupled to a memory and configured to implement any of aspects 28 to 48, further including a transceiver coupled to the at least one processor.

Aspect 50 is an apparatus for wireless communication including means for implementing any of aspects 28 to 48.

Aspect 51 is a non-transitory computer-readable medium storing computer executable code, where the code when executed by a processor causes the processor to implement any of aspects 28 to 48.

Aspect 52 is a method of wireless communication at a UE, including configuring a first frequency band or a first CC dedicated for WET from one or more frequency bands or one or more CCs associated with the WET for a network entity to transmit a first energy signal in the first frequency band dedicated for the WET to a UE, configuring at least one WIT band including one or more of a DL WIT band carrying a DL channel, an UL WIT band carrying an UL channel, or a SL WIT band carrying a SL channel for the UE to communicate a data signal with the network node or another UE, and communicating the data signal with the UE in the at least one WIT band.

Aspect 53 is the method of aspect 52, where the configuring the first frequency band dedicated for WET includes transmitting a grant to the network entity to transmit the first energy signal on the first frequency band.

Aspect 54 is the method of aspect 53, where the configuring the first frequency band dedicated for WET includes receiving a message reserving the first frequency band for transmitting the first energy signal from the network entity, where the grant to the network entity to transmit the first energy signal on the first frequency band is transmitted based on the message reserving the first frequency band from the network entity.

Aspect 55 is the method of any of aspects 52 to 54, where the first CC is dedicated for WET across multiple cells, and the one or more CCs associated with the WET includes at least one CC configured for WET in a particular cell.

Aspect 56 is the method of any of aspects 52 to 55, where the first frequency band dedicated for the WET includes a plurality of sub-channels, and the first energy signal is received in a first sub-channel of the plurality of sub-channels.

Aspect 57 is the method of any of aspects 52 to 56, where the first energy signal is configured based on the first frequency band.

Aspect 58 is the method of aspect 57, where the at least one configuration of the first energy signal includes EIRP or PSD.

Aspect 59 is the method of any of aspects 57 and 58, further including communicating a data signal in a RAT band adjacent to the first frequency band in frequency domain, where the RAT band is not based on an ACLR caused by the data signal in the WET band.

Aspect 60 is the method of any of aspects 57 to 59, further including communicating a data signal in a RAT band adjacent to the first frequency band in frequency domain, where the first energy signal is configured based on an ACLR caused by the first energy signal in the RAT band.

Aspect 61 is the method of aspect 60, where the RAT band is configured to carry a data signal and a mitigating signal, the mitigating signal configured to reduce the ACLR in the RAT band caused by the first energy signal transmitted in the first frequency domain.

Aspect 62 is the method of any of aspects 52 to 61, further including communicating the data signal in at least one of a DL channel, an UL channel or a SL channel, where the at least one of the DL channel, the UL channel, or the SL channel is communicated in at least one WIT band including one or more of a DL WIT band carrying the DL channel, an UL WIT band carrying the UL channel, or a SL WIT band carrying the SL channel.

Aspect 63 is the method of aspect 62, where the first frequency band dedicated for the WET and the at least one WIT band are TDD.

Aspect 64 is the method of any of aspects 62 and 63, where the first frequency band dedicated for the WET and the at least one WIT band are FDD.

Aspect 65 is the method of aspect 64, where a duplex gap is configured between the first frequency band and the at least one WIT band.

Aspect 66 is the method of any of aspects 64 and 65, where the DL WIT band overlaps with the first frequency band in a frequency domain.

Aspect 67 is the method of any of aspects 64 to 66, where a guard band is configured between the first frequency band and the DL WIT band, and a duplex gap is configured between the first frequency band and the UL WIT band, the duplex gap being greater than the guard band.

Aspect 68 is the method of any of aspects 64 to 67 where the UL WIT band and the DL WIT band are TDD.

Aspect 69 is the method of any of aspects 62 to 68, where the first frequency band includes a plurality of sub-channels, and the first energy signal is received in a first sub-channel of the plurality of sub-channels, and the at least one WIT band overlaps with a second sub-channel of the plurality of sub-channels.

Aspect 70 is the method of any of aspects 69, where a guard band is configured between the first sub-channel and the second sub-channel.

Aspect 71 is the method of any of aspects 69 and 70, where the UL WIT band and the DL WIT band are TDD in the second sub-channel.

Aspect 72 is an apparatus for wireless communication including at least one processor coupled to a memory and configured to implement any of aspects 52 to 71, further including a transceiver coupled to the at least one processor.

Aspect 73 is an apparatus for wireless communication including means for implementing any of aspects 52 to 71.

Aspect 74 is a non-transitory computer-readable medium storing computer executable code, where the code when executed by a processor causes the processor to implement any of aspects 52 to 71.

What is claimed is:

1. An apparatus for wireless communication at a user equipment (UE), comprising:
a memory; and
at least one processor coupled to the memory and configured to:
receive a first energy signal in a first frequency band or a first component carrier (CC) dedicated for wireless energy transmission (WET) from one or more frequency bands or one or more CCs associated with the WET; and
harvest radio-frequency energy from the first energy signal using a power harvesting circuit based on receiving the first energy signal in the first frequency band dedicated for the WET.

2. The apparatus of claim 1, wherein the power harvesting circuit has a configurable impedance configured based on the first frequency band dedicated for the WET.

3. The apparatus of claim 2, wherein the at least one processor is further configured to:
obtain, within the first CC, an indication of a second CC of the one or more CCs associated with the WET;
tune the configurable impedance of the power harvesting circuit based on the second CC; and
harvest the radio-frequency energy from a second energy signal received in the second CC using the power harvesting circuit having the configurable impedance tuned based on the second CC.

4. The apparatus of claim 1, wherein the first frequency band dedicated for the WET comprises a plurality of sub-channels, and the first energy signal is received in a first sub-channel of the plurality of sub-channels,
wherein the at least one processor is further configured to indicate that a power density of the first energy signal received in the first sub-channel is less than a threshold value.

5. The apparatus of claim 4, wherein the at least one processor is further configured to: receive a third energy signal in a second sub-channel of the plurality of sub-channels, based on the indication that the power density of the first energy signal received in the first sub-channel is less than the threshold value.

6. The apparatus of claim 1, wherein the at least one processor is further configured to: receive a WET instruction to receive the first energy signal in the first frequency band from a network entity,
wherein the first energy signal is received in the first frequency band based on the received WET instruction.

7. The apparatus of claim 1, wherein the at least one processor is further configured to: transmit a WET request to a network entity to transmit the first energy signal in the first frequency band,
wherein the first energy signal is received in the first frequency band based on the received WET request.

8. The apparatus of claim 1, wherein the at least one processor is further configured to communicate data signal in at least one of a downlink (DL) channel, an uplink (UL) channel or a sidelink (SL) channel,
wherein the at least one of the DL channel, the UL channel, or the SL channel is communicated in at least one wireless information transmission (WIT) band including one or more of a DL WIT band carrying the DL channel, an UL WIT band carrying the UL channel, or a SL WIT band carrying the SL channel.

9. The apparatus of claim 8, wherein the first frequency band dedicated for the WET and the at least one WIT band are time division duplexed (TDD).

10. The apparatus of claim 8, wherein the first frequency band dedicated for the WET and the at least one WIT band are frequency division duplexed (FDD).

11. The apparatus of claim 10, further comprising:
a first antenna configured to receive the first frequency band dedicated for the WET; and
a second antenna configured to receive at least a part of the at least one WIT band.

12. The apparatus of claim 10, wherein the DL WIT band overlaps with the first frequency band in a frequency domain.

13. The apparatus of claim 10, wherein the UL WIT band and the DL WIT band are time division duplexed (TDD).

14. The apparatus of claim 8, wherein the first frequency band comprises a plurality of sub-channels, and the first energy signal is received in a first sub-channel of the plurality of sub-channels, and the at least one WIT band overlaps with a second sub-channel of the plurality of sub-channels.

15. The apparatus of claim 14, wherein a guard band is configured between the first sub-channel and the second sub-channel.

16. The apparatus of claim 14, wherein the UL WIT band and the DL WIT band are time division duplexed (TDD) in the second sub-channel.

17. An apparatus for wireless communication at a network entity, comprising:
a memory; and
at least one processor coupled to the memory and configured to:
obtain an indication of a first frequency band or a first component carrier (CC) dedicated for wireless energy transmission (WET) from one or more frequency bands or one or more CCs associated with the WET; and
transmit a first energy signal in the first frequency band dedicated for the WET to a user equipment (UE).

18. The apparatus of claim 17, wherein, to obtain the indication of the first frequency band dedicated for the WET, the at least one processor is configured to receive a grant to transmit the first energy signal on the first frequency band from a network node,
wherein the first energy signal is transmitted in the first frequency band based on receiving the grant from the network node.

19. The apparatus of claim 18, wherein, to obtain the indication of the first frequency band dedicated for the WET, the at least one processor is further configured to transmit a message reserving the first frequency band for transmitting the first energy signal to the network node,
wherein the grant is received based on the message reserving the first frequency band transmitted to the network node.

20. The apparatus of claim 17, wherein, to obtain the indication of the first frequency band dedicated for the WET, the at least one processor is further configured to receive a WET request from the UE to transmit the first energy signal,
wherein the first energy signal is transmitted in the first frequency band based on receiving the WET request from the UE.

21. The apparatus of claim 17, wherein, to obtain the indication of the first frequency band dedicated for the WET, the at least one processor is further configured to perform an energy detection in the first frequency band,
wherein the first energy signal is transmitted in the first frequency band based on an outcome of the energy detection in the first frequency band is less than or equal to a threshold value.

22. The apparatus of claim 21, wherein the energy detection is performed in at least one of:
a guard band of the first frequency band dedicated for the WET;
the first frequency band dedicated for the WET; or
each sub-channel of the first frequency band dedicated for the WET.

23. The apparatus of claim 17, wherein the first frequency band dedicate for the WET comprises a plurality of sub-channels, and the first energy signal is received in a first sub-channel of the plurality of sub-channels,
wherein the at least one processor is further configured to receive an indication that a power density of the first energy signal received at the UE in the first sub-channel is less than a threshold value.

24. The apparatus of claim 23, wherein the at least one processor is further configured to transmit a third energy signal in a second sub-channel of the plurality of sub-channels based on receiving the indication that the power density of the first energy signal received at the UE in the first sub-channel is less than the threshold value.

25. The apparatus of claim 24, wherein the at least one configuration of the first energy signal includes equivalent isotropic radiated power (EIRP) or power spectrum density (PSD).

26. The apparatus of claim 24, wherein the at least one configuration of the first energy signal is based on an adjacent channel leakage power (ACLR) caused by the first energy signal in a radio access technology (RAT) band carrying a data signal between the UE and a network node, the RAT band being adjacent to the first frequency band in frequency domain.

27. The apparatus of claim 26, wherein the data signal is transmitted in the RAT band and a mitigating signal is transmitted in the WET band, the mitigating signal configured to reduce the ACLR caused the data signal transmitted in the RAT band.

28. An apparatus for wireless communication at a network node, comprising:
a memory; and
at least one processor coupled to the memory and configured to:
configure a first frequency band or a first component carrier (CC) dedicated for wireless energy transmission (WET) from one or more frequency bands or one or more CCs associated with the WET for a network entity to transmit a first energy signal in the first frequency band dedicated for the WET to a user equipment (UE);
configure at least one wireless information transmission (WIT) band including one or more of a downlink (DL) WIT band carrying a DL channel, an uplink (UL) WIT band carrying an UL channel, or a sidelink (SL) WIT band carrying a SL channel for the UE to communicate a data signal with the network node or another UE; and
communicate the data signal with the UE in the at least one WIT band.

29. The apparatus of claim 28, wherein, to configure the first frequency band dedicated for the WET, the at least one processor is configured to:
receive a message reserving the first frequency band for transmitting the first energy signal from the network entity; and
transmit a grant to the network entity to transmit the first energy signal on the first frequency band based on the message reserving the first frequency band from the network entity.

30. A method of wireless communication at a user equipment (UE), comprising:
receiving a first energy signal in a first frequency band or a first component carrier (CC) dedicated for wireless energy transmission (WET) from one or more frequency bands or one or more CCs associated with the WET; and
harvesting radio-frequency energy from the first energy signal using a power harvesting circuit based on receiving the first energy signal in the first frequency band dedicated for the WET.
